(19) United States
(12) Patent Application Publication
(10) Pub. No.: US 2015/0027055 A1
(43) Pub. Date: Jan. 29, 2015

(54) SEPARATION OF HYDROGEN SULFIDE FROM NATURAL GAS

(71) Applicants: Pavel Kortunov, Flemington, NJ (US); Michael Siskin, Westfield, NJ (US); Robert B. Fedich, Long Valley, NJ (US)

(72) Inventors: Pavel Kortunov, Flemington, NJ (US); Michael Siskin, Westfield, NJ (US); Robert B. Fedich, Long Valley, NJ (US)

(73) Assignee: EXXONMOBIL RESEARCH AND ENGINEERING COMPANY, Annandale, NJ (US)

(21) Appl. No.: 14/339,768

(22) Filed: Jul. 24, 2014

Related U.S. Application Data
(60) Provisional application No. 61/859,325, filed on Jul. 29, 2013.

(51) Int. Cl. C10L 3/10; B01D 53/14

(52) U.S. Cl. CPC C10L 3/103; B01D 53/1481; B01D 2252/204; B01D 2252/20426; B01D 2252/20431; B01D 2252/20478; C10L 2290/541
USPC 48/127.3; 95/235

(57) ABSTRACT

A process for increasing the selectivity of an alkanolamine absorption process for selectively removing hydrogen sulfide (H₂S) from a gas mixture which also contains carbon dioxide (CO₂) and possibly other acidic gases such as COS, HCN, CS₂ and sulfur derivatives of C₁ to C₄ hydrocarbons, comprises contacting the gas mixture with a liquid absorbent which is a severely sterically hindered capped alkanolamine or more basic sterically hindered secondary and tertiary amine. The improvement in selectivity is achieved at the high(er) pressures, typically least about 10 bara at conditions nearing the H₂S/CO₂ equilibrium at which CO₂ begins to displace absorbed hydrosulfide species from the absorbent solution.

This application claims priority under 35 USC 120 from U.S. Application Ser. No. 61/859,325, filed 29 Jul. 2013.

### FIELD OF THE INVENTION

This invention relates to a process for removing acid gases from natural gas and other gas streams at high pressure. In particular, it relates to a process for selectively removing hydrogen sulfide from these gas mixtures in the presence of carbon dioxide.

### BACKGROUND OF THE INVENTION

A number of different technologies are available for removing acid gases such as carbon dioxide, hydrogen sulfide, carbonyl sulfide. These processes include, for example, chemical absorption (amine), physical absorption, cryogenic distillation (Ryan Holmes process), and membrane system separation. Of these, amine separation is a highly developed technology with a number of competing processes in hand using various amine sorbents such as monoethanolamine (MEA), diethanolamine (DEA), triethanolamine (TEA), methyldiethanolamine (MDEA), diisopropylamine (DIPA), diglycolamine (DGA), 2-amino-2-methyl-1-propanol (AMP) and piperazine (PZ). Of these, MEA, DEA, and MDEA are the ones most commonly used. The amine purification process usually contacts the gas mixture countercurrently with an aqueous solution of the amine in an absorber tower. The liquid amine stream is then regenerated by desorption of the absorbed gases in a separate tower with the regenerated amine and the desorbed gases leaving the tower as separate streams. The various gas purification processes which are available are described, for example, in Gas Purification, Fifth Ed., Kohl and Neilsen, Gulf Publishing Company, 1997, ISBN-13: 978-0-88415-220-0.

It is often necessary or desirable to treat acid gas mixtures containing both CO₂ and H₂S so as to remove the H₂S selectively from the mixture while minimizing removal of the CO₂. While removal of CO₂ may be necessary to avoid corrosion problems and provide the required heating value to the consumer, selective H₂S removal may be necessary or desirable. Natural gas pipeline specifications, for example, set more stringent limits on the H₂S level than on the CO₂ since the H₂S is more toxic and corrosive than CO₂: common carrier natural gas pipeline specifications typically limit the H₂S content to 4 ppmv with a more lenient limitation on the CO₂ at 2 vol %. Selective removal of the H₂S may enable a more economical treatment plant to be used and selective H₂S removal is often desirable to enrich the H₂S level in the feed to a sulfur recovery unit.

The reaction kinetics with hindered amine sorbents allow H₂S to react more rapidly with the amine groups of the sorbent to form a hydrosulfide salt in aqueous solution but under conditions of extended gas-liquid contact where equilibrium of the absorbed sulfidic species with CO₂ is approached, carbon dioxide can displace hydrogen sulfide from the previously absorbed hydrosulfide salt since carbon dioxide is a slightly stronger acid in aqueous solution than hydrogen sulfide (ionization constant for the first ionization step to H⁺ and HCO₃⁻ is approximately 4×10⁻⁷ at 25° C. compared to 1×10⁻⁷ for the corresponding hydrogen sulfide ionization) so that under near equilibrium conditions, selective H₂S removal becomes problematical, presenting a risk of excessive H₂S levels in the effluent product gas stream.

An improvement in the basic amine process involves the use of sterically hindered amines. U.S. Pat. No. 4,112,052, for example, describes the use of hindered amines for nearly complete removal of acid gases including CO₂ and H₂S. U.S. Pat. Nos. 4,405,581; 4,405,583; 4,405,585 and 4,471,138 disclose the use of severely sterically hindered amine compounds for the selective removal of H₂S in the presence of CO₂. Compared to aqueous MDEA, severely sterically hindered amines lead to much higher selectivity at high H₂S loadings. Amines described in these patents include BTEE (bis(tertiary-butylamino)-ethoxy-ethane synthesized from tertiary-butylamine and bis-(2-chloroethoxy)-ethane as well as EEETB (ethoxyethoxyethanol-tertiary-butylamine) synthesized from tertiary-butylamine and chloroethoxyethoxyethanol). U.S. Pat. No. 4,894,178 indicates that a mixture of BTEE and EEETB is particularly effective for the selective separation of H₂S from CO₂. U.S. 2010/0037775 describes the preparation of alkoxy-substituted etheramines as selective sorbents for separating H₂S from CO₂.

The use of hydroxyl-substituted amines (alkanolamines) such as those mentioned above has become common since the presence of the hydroxyl groups tends to improve the solubility of the absorbent/acid gas reaction products in the aqueous solvent systems widely used, so facilitating circulation of the solvent through the conventional absorber tower/regeneration tower unit. This preference may, however, present its own problems in certain circumstances. A current business driver is to reduce the cost to regenerate and to recompress acid gases prior to sequestration. For natural gas systems, the separation of the acid gases can occur at pressures of about 4,800-15,000 kPaa (about 700-2,200 psia), more typically from about 7,250-8,250 kPaa (about 1050-1200 psia). While the alkanolamines will effectively remove acid gases at these pressures, the selectivity for H₂S removal can be expected to decrease markedly both by direct physisorption of the CO₂ in the liquid solvent and by reaction with the hydroxyl groups on the amine compound. Although the CO₂ reacts preferentially with the amino nitrogen, higher pressures force reaction with the oxygens and under the higher pressures, the bicarbonate/hemicarbonate/carbonate reaction product formed by the reaction at the hydroxyl site is stabilized with a progressive loss in H₂S selectivity with increasing pressure. This effect can be perceived, for example, with MDEA (N-methyl diethanolamine). For example, 5M MDEA in aqueous solution does not absorb carbon dioxide under ambient conditions, but will form a hydrosulfide salt at the nitrogen. However, H₂S/CO2 selectivity significantly reduces at high CO₂ pressure presumably due to O-carbonation of hydroxyl groups:

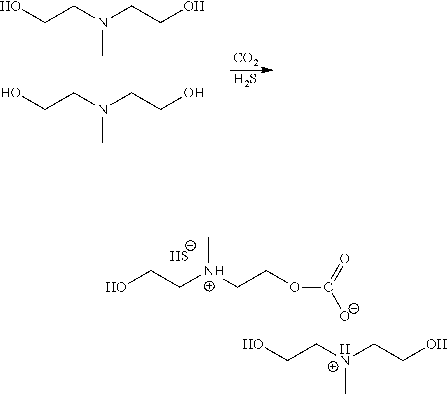

A similar trend is observed with the secondary aminoether, ethoxyethoxyethanol-t-butylamine (EEETB): at low pressures, this absorbent offers H₂S selectivity over CO₂ based on a faster reaction with the hindered secondary amine group although a significant amount of CO₂ can be absorbed by the hydroxyl group which has low affinity to H₂S. At higher pressures, however, the reaction yield of O-carbonation increases, suppressing the H₂S/CO₂ selectivity achieved by the hindered secondary amine:

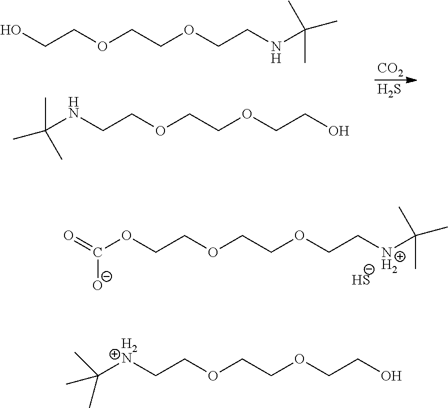

There is therefore a need for an alkanolamine absorbent system that can selectively absorb H₂S from gas mixtures that also contain CO₂ and that can be regenerated at high pressure and relatively low temperature while maintaining very low CO₂ solubility. This can significantly reduce the cost and energy required for regeneration and recompression as well as improving operation of the sulfur recovery plant.

### SUMMARY OF THE INVENTION

We have now found that it is possible to achieve improved selectivity for the removal of H₂S from gas mixtures also containing CO₂ at high(er) pressures by the use of capped alkanolamines and more basic sterically hindered secondary and tertiary amines as the absorbent. This effect is particularly useful when treating natural gas streams where reinjection of the carbon dioxide into the subterranean producing formation is to be carried out since CO₂ recompression costs are reduced with the separation being operated at the higher pressures requisite for injection back into the formation.

According to the present invention therefore, a process for increasing the selectivity of an alkanolamine/amine absorption process for H₂S absorption) from a gas mixture which also contains carbon dioxide (CO₂) and possibly other acidic gases such as COS, HCN, CS₂ and sulfur derivatives of C1 to C4 hydrocarbons, comprises contacting the gas mixture with a liquid absorbent which is a severely sterically hindered capped alkanolamine or a more basic sterically hindered secondary and tertiary amine; the contacting and regeneration of the absorbent is carried out at high(er) pressure, preferably, at a pressure of at least about 10 bara (about 147 psia) so that selectivity for removal of the H₂S relative to the CO₂ removal is achieved at a level above that prevailing under ambient pressure (about 1 bara, 14.7 psia). The selectivity described here signifies that the present process is capable of removing H₂S in preference to the CO₂, that is, the molar proportion of absorbed H₂S is greater than the molar proportion of absorbed CO₂. This H₂S selectivity is achieved according to the kinetics of the respective absorption mechanisms by appropriate control of process conditions notably, the contact time between the gas stream and the liquid absorbent as discussed below.

In its typical mode of application the amine separation process for a natural gas stream which contains both H₂S and CO₂ achieves improved selectivity for H₂S separation (relative to CO₂ separation) under higher pressure conditions. It functions by:
(i) contacting a natural gas stream containing H₂S and CO₂ in an absorption zone with a liquid solution (aqueous or non-aqueous) of a severely sterically hindered capped alkanolamine or a more basic sterically hindered secondary and tertiary amine to absorb H₂S in preference to CO₂ and form a rich stream of the absorbed H₂S in the alkanolamine solution;
(ii) passing the rich stream from the absorption zone to at least one regeneration zone and desorbing the absorbed H₂S as gas from the amine solution to form a lean solution containing a reduced concentration of absorbed H₂S relative to the rich stream and
(iii) returning the lean stream to the absorption zone.

When the absorbent is a capped alkanolamine, that is, an alkanolamine in which one or more of the hydroxyl groups have been capped or converted into ether groups, exemplary amine absorbents of this type include, for example, the following:

N-(2-methoxyethyl)-N-methyl-ethanolamine (MDEA-(OMe),

Bis-(2-methoxyethyl)-N-methylamine (MDEA-(OMe)₂),

2-amino-prop-1-yl methyl ether (AP-OMe),

2-methyl-2-amino-prop-1-yl methyl ether (AMP-OMe),

2-N-methylamino-prop-1-yl methyl ether (MAP-OMe),

2-N-methylamino-2-methyl-prop-1-yl methyl ether (MAMP-OMe),

2-N-ethylamino-2-dimethyl-prop-1-yl methyl ether, (EAMP-OMe),

2-(N,N-dimethylamino)-ethyl methyl ether (DMAE-OMe),

Methoxyethoxyethoxyethanol-t-butylamine (MEEETB).

When the absorbent is a more basic sterically hindered secondary and tertiary amine, preferred structures include guanidines, amidines, biguanides, piperidines, piperazines, and the like. Tetramethyguanidine, pentamethylguanidine, 1,4-dimethylpiperazine, 1-methylpiperidine, 2-methylpiperidine, 2,6-dimethylpiperidine are examples.

### DRAWINGS

In the accompanying drawings:

FIG. 1 is a simplified diagrammatic illustration of a cyclic absorption unit suitable for use in the present invention;

FIG. 2 is a graphical depiction of the results of testing CO₂ absorption by 2-N-methylamino-2-methyl-prop-1-yl methyl ether (MAMP-OMe) in aqueous and non-aqueous solution and MAMP in aqueous solution;

FIG. 3 is a graphical depiction of the results of testing CO₂ absorption by bis-(2-methoxyethyl)-N-methylamine (MDEA-(OMe)₂) in aqueous and non-aqueous solution and MDEA in aqueous solution;

FIG. 4 is a graphical depiction of the results of testing CO₂ absorption by 2-amino-2-methylprop-1-yl methyl ether (MeO-AMP) in aqueous and non-aqueous solution and AMP in aqueous solution;

FIG. 5 is a graphical depiction of the results of testing CO₂ absorption by 2-N-methylamino-prop-1-yl methyl ether (MeO-MAP and) MAP in aqueous solution;

FIG. 6 is a graphical depiction of the concentrations of H₂S and CO₂ in the reactor off-gas without and with the amine solution of MDEA-(MeO)₂ (1M) in NMP;

FIG. 7 is a graphical depiction of the rates of H₂S and CO₂ capture by a 1M solution of MDEA-(MeO)₂ in NMP derived from the breakthrough curves shown in FIG. 6;

FIG. 8 is a graphical depiction of the selectivity of H₂S removal by a 1M solution of MDEA-(MeO)₂ in NMP;

FIG. 9 is a graphical depiction of the concentrations of H₂S and CO₂ in the reactor off-gas without and with amine solution of MDEA-(MeO)₂ (neat);

FIG. 10 is a graphical depiction of the rates of H₂S and CO₂ capture by neat MDEA-(MeO)₂ derived from the breakthrough curves shown in FIG. 9;

FIG. 11 is a graphical depiction of the selectivity of H₂S removal by neat MDEA-(MeO)₂;

FIG. 12 is a graphical depiction of the concentrations of H₂S and CO₂ in the reactor off-gas without and with amine solution containing MeO-MAMP (1M) in NMP;

FIG. 13 is a graphical depiction of the rates of H₂S and CO₂ capture by a 1M solution of MeO-MAMP in NMP derived from the breakthrough curves shown in FIG. 12;

FIG. 14 is a graphical depiction of the selectivity of H₂S removal by a 1M solution of MeO-MAMP in NMP;

FIG. 15 is a graphical depiction of the concentrations of H₂S and CO₂ in the reactor off-gas without and with a 1M solution of TMG in NMP;

FIG. 16 is a graphical depiction of the rates of H₂S and CO₂ capture by a 1M TMG solution in NMP;

FIG. 17 is a graphical depiction of the selectivity of H₂S removal by a 1M solution of TMG in NMP;

FIG. 18 is a graphical depiction of the concentrations of H₂S and CO₂ in the reaction vessel off-gas without and with a 1M solution of TMG in DMSO;

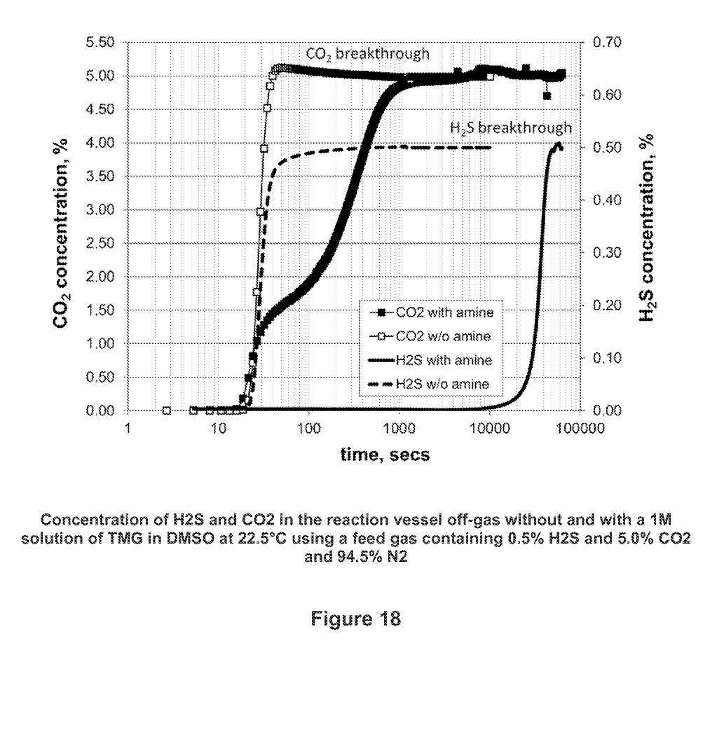

FIG. 19 is a graphical depiction of the rates of H₂S and CO₂ capture by a 1M TMG solution in DMSO; and

FIG. 20 is a graphical depiction of the selectivity of H₂S removal by a 1M solution of TMG in DMSO.

### DETAILED DESCRIPTION

### General Considerations

The present selective gas separation process is particularly apt for use in the treatment of natural gas which is normally compressed subsequent to gathering from the wellheads for treatment prior to pipelining. Interstate gas transmission lines are usually operated at pressures above 15 bara (about 220 psia) and in most cases in the range of 15 to 100 bara (about 217 to 1450 psia) for economy in transmission by reduction of gas volume. At pressures of this magnitude, the stability and capacity of the H₂S/absorbent reaction products is markedly increased as the effect of the pressure is to move equilibrium to the right in the sorption reaction:

R¹—O—R²—NHR³+H₂S→R¹—O—R²—NH₂⁺R³HS⁻

where R¹, R² and R³ are the groups, usually alkyl or alkylene in the absorbent molecule as described below. The carbonation of the hydroxyl group(s) is no longer permitted by the capping group so that selectivity under these pressure conditions is notably enhanced. At the same time, the regenerability of the absorbent is improved. The absorbed H₂S may be released from the hydrosulfide salt formed by reaction at the amino nitrogen amine by a reduction in pressure at a relatively low temperature; significantly lower than the regeneration temperatures conventionally used above about 90° C.; desorption temperatures of from about 40 to 70° C. become usable, with a considerable savings in the energy required in the overall sorption-desorption process. Alternatively, with the stability of the H₂S/amine strongly dependent on pressure, the separation process may be operated on a pressure swing cycle with a reduction in pressure to desorb the H₂S and regenerate, or partially regenerate the capped amine absorbent.

### Process Configuration

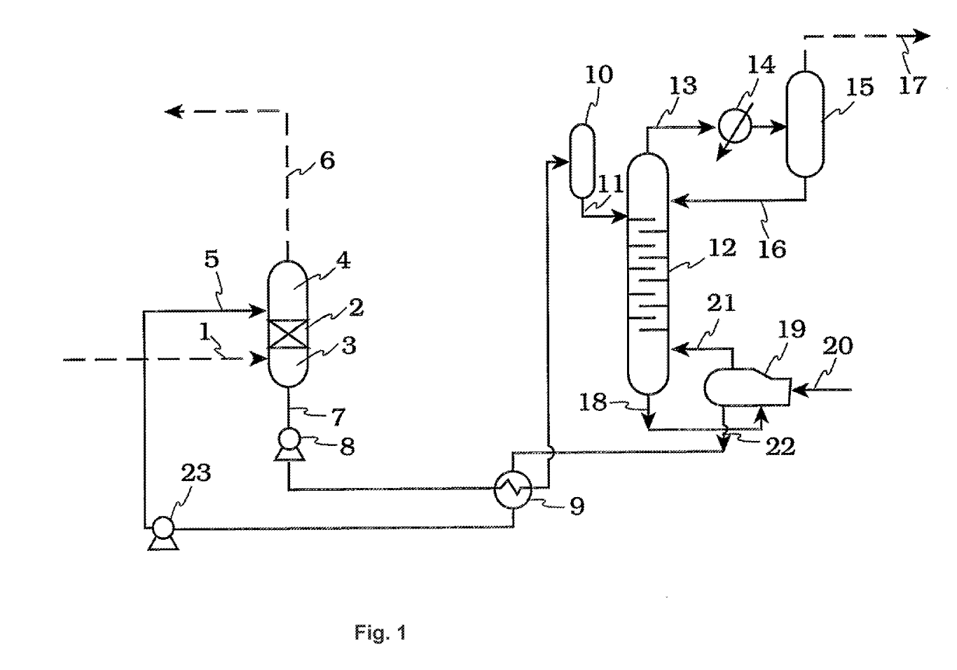

The separation process may be carried out in a cyclic liquid sorbent gas separation unit as illustrated in FIG. 1 which, in this case, operates in the temperature swing (TSA) mode with the regeneration effected by an increase in temperature. The gas mixture to be purified is introduced through line 1 into the lower portion of a gas-liquid countercurrent contacting column 2, which has a lower section 3 and an upper section 4. The upper and lower sections may be segregated by one or more packed beds or trays. The absorbent solution is introduced into the upper portion of the column through line 5. The solution flows down through the column and contacts the countercurrent flow of the gas to allow the absorbent to absorb the H₂S preferentially during the limited time the gas is in contact with the absorbent. The gas with the H₂S reduced to a low level then exits through line 6, for final use, e.g., transmission or further treatment. The solution, containing absorbed H₂S and some CO₂, referred to as the “rich” solution, flows to the bottom portion of the column from which it is discharged through line 7. The rich solution is then pumped by optional pump 8 through an optional heat exchanger 9 in line 7, which allows the hot solution from the regenerator 12 to exchange heat with the cooler solution from the absorber column 2 for energy conservation. The rich solution enters flash drum 10 from line 7 and is then pumped through an optional pump through an optional heat exchanger and then introduced by line 11 into the upper portion of the regenerator 12; the flash drum is equipped with a line (not shown) which vents to line 13. The regenerator 12 is equipped with a series of trays or packed beds and effects the desorption of the H₂S from the rich solution. The released gas is passed through line 13 into a condenser 14 where cooling and condensation of water and amine solution from the gas take place. The gas then enters a separator 15. The condensed solution is returned through pipe 16 to the upper portion of the regenerator 12. The gas remaining from the condensation, which contains H₂S, is removed through pipe 17 for final disposal (e.g., to a vent or incinerator or to a sulfur recovery plant such as a Modified Claus unit or a Stretford unit (not shown).

The absorbent solution, which is liberated from most of the absorbed gas while flowing downward through regenerator 12, exits through line 18 at the bottom of the regenerator for transfer to a reboiler 19. Reboiler 19, equipped with an external source of heat (e.g., steam injected through line 20 and the condensate exits through a second line (not shown)), vaporizes a portion of this solution (mainly water) to force the release of more H₂S. The H₂S and steam driven off are returned via line 21 to the lower section of regenerator 12 and exit through line 13 for entry into the condensation stages of gas treatment. The solution remaining in the reboiler 19, referred to as the “lean” solution, is drawn through line 22, cooled in heat exchanger 9, and introduced by the action of pump 23 (optional if pressure is sufficiently high) through line 5 into the absorber column 2 for re-use.

### Absorption/Regeneration Process

The stability of the absorbed species generally decreases with increasing temperature so that absorption of the H₂S will favored by lower temperatures. With natural gas streams, the temperature will usually be low enough to favor absorption, particularly if the gas has been passed through an expansion before entering the unit. The absorption temperature will typically be at least 10° C. and in most cases at least 15 to 20° C. with the most typical range being about 25° C. to 30° C.; the upper limit on absorption temperature will not normally extend above about 90° C. and will normally not exceed about 50 to 75° C. In most cases, however, a maximum temperature for the sorption will be 75° C. and if operation is feasible at a lower temperature, e.g., with a chilled incoming natural gas, resort may be advantageously made to lower temperatures at this point in the cycle.

The sorption solution may include a variety of additives typically employed in selective gas removal processes, e.g., antifoaming agents, anti-oxidants, corrosion inhibitors. The amount of these additives will typically be in the range that they are effective.

As will be apparent from the following discussion, the selective character of the present absorption process in which the H₂S is preferentially absorbed by capped primary and secondary alkanolamines is achieved by the absorption kinetics which initially favor the reaction with the H₂S although this reaction is less thermodynamically favored; continued exposure to the carbon dioxide permits displacement of the initial hydrosulfide kinetic reaction product by a carbonate/bicarbonate reaction product formed with the CO₂. During the sorption step, therefore, the kinetics favoring H₂S absorption are exploited by limiting mass transfer and using short contact times so that the incoming gas mixture does not remain in contact with the absorbent for the CO₂ to substantially displace the absorbed H₂S. The mass transfer zone designed correctly and the contact time between the incoming gas stream and the absorbent should therefore be monitored and controlled (i.e., of alternate amine inlets) so as to take advantage of the kinetics favoring H₂S sorption over the CO₂ reaction. Contact times less than 5 minutes and preferably less than 1 minute are effective with H₂S selectivity increasing with shorter contact times since opportunities for displacement of absorbed sulfidic species by CO₂ are correspondingly reduced. Flow rates in the cyclic operation should therefore be controlled accordingly.

### Sorption

For absorption, the temperature is typically in the range of from about 25° C. to about 90° C., preferably from about 20° C. to about 75° C.; the stability of the H₂S/amine species generally decreases with increasing temperature. In most cases, however, a maximum temperature for the sorption will be 75° C. and if operation is feasible at a lower temperature, e.g., with a chilled incoming natural gas or refinery process stream, resort may be advantageously made to lower temperatures at this point in the cycle. Temperatures below 50° C. are likely to be favored for optimal sorption and selectivity.

The minimum pressure is typically about 1.0 bar (absolute) e.g. 1.1 bara, and often above this value, e.g. 10 bara to 15 bara, depending on the handling of the gas stream prior to entering the separation unit. Maximum pressures will not normally exceed about 150 bara and again will vary according to the previous handling of the gas, and in most cases not more than 100 bara or even lower, e.g., 70 bara, 50 bara, 40 bara, 30 bara or 20 bara. The partial pressures of hydrogen sulfide and carbon dioxide in the gas mixture will vary according to the gas composition and the pressure of operation. The gas mixture can be contacted counter currently or co-currently with the absorbent material at a typical gas hourly space velocity (GHSV) of from about 50 (S.T.P.)/hour to about 50,000 (S.T.P.)/hour with the higher velocities favored with aqueous solutions as noted above to disfavor displacement of absorbed H₂S by CO₂ with longer contact times.

### Desorption

The H₂S can be desorbed from the absorbent material by conventional methods. One possibility is to desorb the absorbed H₂S by means of stripping with an inert (non-reactive) gas stream such as nitrogen in the regeneration tower. The reduction in the H₂S partial pressure which occurs on stripping promotes desorption of the H₂S and when this expedient is used, there is no requirement for a significant pressure reduction although the pressure may be reduced for optimal stripping, suitably to the levels used in pressure swing operation.

When carrying out the desorption by inert gas sparging or pressure swing operation, the temperature may be maintained at a value at or close to that used in the sorption step. Desorption, will however, be favored by an increase in temperature, either with or without stripping or a decrease in pressure.

The H₂S can be desorbed from the absorbent material by conventional methods including temperature swing, pressure swing and stripping with an inert (non-reactive) gas stream such as nitrogen, CO₂, or steam in the regeneration tower. Temperature swing operation is often a choice in conventional cyclic absorption plants. The temperature of the rich solution from the absorption zone is raised in the regeneration tower, e.g., by passage through a heat exchanger at the bottom of the regeneration tower or with steam or other hot gas. Desorption temperatures will be dependent on the vapor/liquid equilibria for the selected system, e.g. alkanolamine, H₂S concentration, and will typically be 10° C. or more, and in most cases 15 to 50° C. above the temperature in the absorption zone. Typical temperatures in the regeneration zone will be, for example, from a temperature higher than the temperature of the absorption zone and usually at a temperature from 65 to 100° C.; temperatures above 100° C. are not favored with aqueous systems from the viewpoint of energy consumption as a result of the vaporization of the water in the solvent. Higher temperatures above 100° C. may, however, be used if necessary, for example, to ensure desorption or to drive off any accumulated water from a non-aqueous system; when the preferred regeneration temperature is above 100° C., temperatures up to 120° C. are typically used although temperatures above 120° C. may be preferable to desorb the H₂S product at the higher pressures characteristic of this operation. Thermal desorption by passing the rich solution through a hot bath with a head space at controlled pressure (typically above 10 bar) can be a preferred option. Pressure control can be effected by removal of the desorbed gas at an appropriate rate. Pressure swing absorption is likely to be less favored in view of the need for recompression; the pressure drop will be determined by the vapor-liquid equilibria at different pressures.

A slip stream of CO₂ may be used for stripping although this may lead to undesirable CO₂ remaining in the lean gas stream to the absorption zone although desorption can be favored by heating the CO₂ stripping gas. Stripping with steam or an inert (non-reactive) gas is therefore preferred. When carrying out the desorption by inert gas sparging or pressure swing operation, the temperature may be maintained at a value at or close to that used in the sorption step although desorption will be favored by an increase in temperature from the absorption zone to the regeneration zone, either with or without stripping or a decrease in pressure.

In addition to the benefit of improved H₂S selectivity with non-aqueous systems, there are other potential advantages in the regeneration of H₂S-rich amine streams in non-aqueous systems. In the non-aqueous environment, stripping can be feasible with or without purge gas at relatively lower temperatures. The possibility of desorption at lower temperatures offers the potential for isothermal or near isothermal stripping using a purge gas at a temperature the same as or not much higher than the sorption temperature, for example, at a temperature not more than 30° C. higher than the sorption temperature; in favorable cases, it may be possible to attain a sorption/desorption temperature differential of no more than 20° C. When these factors are taken into consideration the temperature selected for the desorption will typically be in the range of from about 70 to about 120° C., preferably from about 70 to about 100° C., and more preferably no greater than about 90° C.

In non-aqueous systems with water present in the stream to be processed, regeneration may need to be performed at a temperature sufficient to remove the water and prevent build-up in the scrubbing loop. In such a situation, the H₂S may be removed at pressures below atmospheric pressure, but above 100° C. For example, the regeneration temperature may be around 90° C., but to remove any water in the sorbent, temperatures in the range of 100 to 120° C. may be required.

For regeneration in non-aqueous systems, stripping with an inert (non-reactive) gas such as nitrogen or a natural gas stream is preferred. Staged heat exchanger systems with intermediate knock out drums in which H₂S/water is removed as a pressurized gas stream may be used as one alternative.

### Solid Phase Operation

Given that the kinetics of the process favor preferential H₂S selectivity with short contact times, the present hindered alkanolamine absorbents or more basic sterically hindered secondary and tertiary amine absorbents may advantageously be operated in the kinetic separation mode using the capped alkanolamines as adsorbents in a thin layer on a solid support. Kinetically based separation processes may be operated, as noted in US 2008/0282884, as pressure swing adsorption (PDA), temperature swing adsorption (TSA), partial pressure swing or displacement purge adsorption (PPSA) or as hybrid processes, as noted in U.S. Pat. No. 7,645,324 (Rode/Xebec). These swing adsorption processes can be conducted with rapid cycles, in which case they are referred to as rapid cycle thermal swing adsorption (RCTSA), rapid cycle pressure swing adsorption (RCPSA), and rapid cycle partial pressure swing or displacement purge adsorption (RCPPSA) technologies, with the term “swing adsorption” taken to include all of these processes and combinations of them.

In the kinetically-controlled PSA processes, the adsorption and desorption are more typically caused by cyclic pressure variation, whereas in the case of TSA, PPSA and hybrid processes, adsorption and desorption may be caused by cyclic variations in temperature, partial pressure, or combinations of pressure, temperature and partial pressure, respectively. In the exemplary case of PSA, kinetic-controlled selectivity may be determined primarily by micropore mass transfer resistance (e.g. diffusion within adsorbent particles or crystals) and/or by surface resistance (e.g. narrowed micropore entrances). For successful operation of the process, a relatively and usefully large working uptake (e.g. the amount adsorbed and desorbed during each cycle) of the first component and a relatively small working uptake of the second component may preferably be achieved. Hence, the kinetic-controlled PSA process requires operation at a suitable cyclic frequency, balancing the avoidance of excessively high cycle frequency where the first component cannot achieve a useful working uptake with excessively low frequency where both components approach equilibrium adsorption values.

The faster the beds perform the steps required to complete a cycle, the smaller the beds can be when used to process a given hourly feed gas flow. Several other approaches to reducing cycle time in PSA processes have emerged which use rotary valve technologies as disclosed in U.S. Pat. Nos. 4,801,308; 4,816,121; 4,968,329; 5,082,473; 5,256,172; 6,051,050; 6,063,161; 6,406,523; 6,629,525; 6,651,658 and 6,691,702. A parallel channel (or parallel passage) contactor with a structured adsorbent may be used to allow for efficient mass transfer in these rapid cycle pressure swing adsorption processes. Approaches to constructing parallel passage contactors with structured adsorbents have been disclosed in US20060169142 A1, US20060048648 A1, WO2006074343 A2, WO2006017940 A1, WO2005070518 A1, and WO2005032694 A1.

The use of the hindered capped alkanolamine or more basic sterically hindered secondary and tertiary amines in the form of a film of controlled thickness on the surface of a core which has a low permeability has significant advantages in rapid cycle processes with cycle durations typically less than one minute and often rather less. By using a thin film, heat accumulation and retention is reduced so that exotherms and hot spots in the absorbent bed are minimized and the need for heat sinks such as the aluminum spheres common in conventional beds can be eliminated by suitable choice of the core material; rapid cycling is facilitated by the fast release of heat from the surface coating and the relatively thin layer proximate the surface of the core. A further advantage is secured by the use of low permeability (substantially non-porous) cores which is that largely inhibit entry of the gas into the interior pore structure of the core material is largely inhibited and so that mass and heat transfer takes place more readily in the thin surface layer; and retention of gas within the pore structure is minimized.

Selectivity for H₂S sorption will be diminished to a certain extent not only by the relative adsorption characteristics of the selected adsorbent material but also by the physical sorption of CO₂ in both liquid and solid systems which becomes more perceivable at higher pressures: the lower the partial pressures of both H₂S and CO₂, the greater will be the selectivity for H₂S. To operate using the capped alkanolamine or more basic sterically hindered secondary and tertiary amine in the solid phase as an adsorbent, the compound is physically or chemically taken up onto on a solid support or carrier material of high surface area. If the basic compound is a solid, it may be dissolved to form a solution which can then be used to impregnate or react with the support material or deposited on it in the form of a thin, wash coat layer of discrete sorbent particles or agglomerates of sorbent particles adhered to the surface of the support. Discrete particles or agglomerates may be adhered effectively by physical interaction at the surface of the support. Porous support materials are generally preferred in view of the greater surface area which they present for the sorption reaction but finely-divided non-porous solids with a sufficiently large surface area may also be used. In either case, the sorbent compound(s) may be physisorbed onto the support material or held onto the surface of the support in the form of a thin, adherent surface layer firmly bonded to the support by physical interaction or alternatively grafted onto the support by chemical reaction.

Porous support materials are frequently used for the catalysts in catalytic processes such as hydrogenation, hydrotreating, hydrodewaxing etc and similar materials may be used for the present sorbents. Common support materials include carbon (activated charcoal) as well as porous solid oxides of metals and metalloids and mixed oxides, including alumina, silica, silica-alumina, magnesia and zeolites. Porous solid polymeric materials are also suitable provided that they are resistant to the environment in which the sorption reaction is conducted. As the components of the gas stream have relatively small molecular dimensions, the minimum pore size of the support is not in itself a severely limiting factor but when the basic nitrogenous compound is impregnated, the entrances to the pore systems of small and intermediate pore size zeolites such as zeolite 4A, erionite, ZSM-5 and ZSM-11 may become occluded by the bulky amine component and for this reason, the smaller pore materials are not preferred, especially with the bases of relatively larger molecular dimensions. Large pore size zeolites with 12-membered ring systems such as ZSM-4, faujasites such as zeolite X and the variants of zeolite Y including Y, REY and USY, may, however, be suitable depending on the dimensions of the basic nitrogenous compound. Amorphous porous solids with a range of different pore sizes are likely to be suitable since at least some of the pores will have openings large enough to accept the basic component and then to leave sufficient access to the components of the gas stream. Supports containing highly acidic reaction sites as with the more highly active zeolites are more likely to be more susceptible to fouling reactions upon reaction with the amino compound and less acidic or non-acidic species are therefore preferred.

A preferred class of solid oxide support is constituted by the mesoporous and macroporous silica materials such as the silica compounds of the M41S series, including MCM-41 (hexagonal) and MCM-48 (cubic) and other mesoporous materials such as SBA-1, SBA-2, SBA-3 and SBA-15 as well as the KIT series of mesoporous materials such as KIT-1. Macroporous silicas and other oxide supports such as the commercial macroporous silicas available as Davisil products are also suitable, e.g. Davisil 634 (6 nm pore size, 480 m²/g pore volume), Davisil 635 (6 nm, 480 m²/g) and Davisil 644 (15 nm, 300 m²/g). According to the IUPAC definition, mesoporous materials are those having a pore size of 2 to 50 nm and the macroporous, those having a pore size of over 50 nm. According to the IUPAC, a mesoporous material can be disordered or ordered in a mesostructure. The preferred mesoporous and macroporous support materials are characterized by a BET surface area of at least 300 and preferably at least 500 m²/g prior to treatment with the base compound. The M41S materials and their synthesis are described in a number of patents of Mobil Oil Corporation including U.S. Pat. Nos. 5,102,643; 5,057,296; 5,098,684 and 5,108,725, to which reference is made for a description of them. They are also described in the literature in “The Discovery of ExxonMobil's M41S Family of Mesoporous Molecular Sieves”, Kresge et al, Studies in Surface Science and Catalysis, 148, Ed. Terasaki, Elsevier bV 2004. SBA-15 is described in “Triblock Copolymer Syntheses of Mesoporous Silica with Periodic 50 to 300 Angstrom Pores”, Dongyuan Zhao, et al. (1998). Science 279 (279). KIT-1 is described in U.S. Pat. No. 5,958,368 and other members of the KIT series are known, for example KIT-5 and KIT-6 (see, e.g. KIT-6 Nanoscale Res Lett. 2009 November; 4(11): 1303-1308). The H₂S/CO₂ selectivity of the material can be adjusted by the judicious choice of the porous support structure, affording a significant potential for tailoring the selectivity of the adsorbent.

The capped alkanolamine or more basic sterically hindered secondary and tertiary amines may simply be physically absorbed on the support material e.g., by impregnation or bonded with or grafted onto it by chemical reaction with the base itself or a precursor or derivative in which a substituent group provides the site for reaction with the support material in order to anchor the sorbent species onto the support. Chemical bonding is not, however, required for an effective solid phase sorbent material; effective sorbents may be formed by physical interaction when the sorbent is itself strongly adsorbed by the support material. Chemical bonding may be effected by the use of support materials which contain reactive surface groups such as the silanol groups found on zeolites and the M41S silica oxides which are capable or reacting with a silylated derivative of the selected amine compound. The high concentrations of surface silanol groups (SiOH), on silica and ordered siliceous materials such as the zeolites and mesoporous materials, e.g. MCM-41, MCM-48, SBA-15 and related structures, render these materials amenable to surface modification by grafting of the functional amine onto the pore walls of the siliceous support via a reaction between the surface silanol groups of the support and the grafting material according to the conventional technique; see, for example, Huang et al., Ind. Eng. Chem. Res., 2003, 42 (12), 2427-2433. The alkoxy groups e.g., methoxy, ethoxy, present in the alkoxy-capped alkanolamines will be capable of reacting with the —OH groups on the surface of the siliceous material with the release of methanol or ethanol to yield a final grafted structure on the surface of the support with grafting taking place through one or more of the alkoxy groups on the capped alkanolamines.

An alternative method of fixing more volatile adsorbing species on the support is by first impregnating the species into the pores of the support and then cross-linking them in place through a reaction which does not involve the basic nitrogenous groups responsible for the sorption reaction in order to render the sorbing species non-volatile under the selected sorption conditions. Grafting or bonding methods are known in the technical literature. The molecular dimensions of the base sorbent should be selected in accordance with the pore dimensions of the support material since bulky bases or their precursors or derivatives may not be capable of entering pores of limited dimensions. A suitable match of base and support may be determined if necessary by empirical means.

Solid phase adsorbents will normally be operated in fixed beds contained in a suitable vessel and operated in the conventional cyclic manner with two or more beds in a unit with each bed switched between sorption and desorption and, optionally, purging prior to re-entry into the sorption portion of the cycle. Purging may be carried out with a steam of the purified gas mixture, i.e. a stream of the gas from which the H₂S has been removed in the sorption process. If operated in temperature swing mode, a cooling step will intervene at some point between desorption and re-entry to sorption; this step will usually constitute a purge after desorption is completed. Alternatively, moving bed systems may be used with particulated solid sorbents or fluidized bed systems with finely-divided solids, e.g. with a particle size up to about 100 μm with the sorbent treated functionally as a liquid circulated between a sorption zone and a desorption/regeneration zone in a manner similar to a fluid catalytic cracking unit; rotating wheel beds are notably useful in rapid cycle sorption systems. All these systems may be operated in their conventional manner when using the present sorbents. Fixed bed systems may be operated with beds of solid porous particulate sorbents, porous monoliths or with layers of the sorbent on a porous or non-porous support For rapid cycle operation it may be possible to operate the separation using thin, adherent wash coats of the sorbent on plate type support elements.

### Capped (Alkanolamine) Absorbents

The capped alkanolamine absorbents used in the present separation process comprise sterically hindered alkanolamines having an ether substituent capping all or some of the hydroxy groups which would otherwise be reactive towards the carbon dioxide to diminish H₂S selectivity.

The steric hindrance required in the alkanolamine absorbent is provided by the group(s) attached to the amino acyclic or cyclic moieties attached to the amino nitrogen atom(s). The term “severely sterically hindered” signifies that the nitrogen atom of the amino moiety is attached to one or more bulky carbon groupings. Typically, the severely sterically hindered aminoether alcohols have a degree of steric hindrance such that the cumulative Es value (Taft's steric hindrance constant) greater than 1.75 as calculated from the values given for primary amines in Table V in D. F. DeTar, Journal of Organic Chemistry, 45, 5174 (1980), to which reference is made for a description of this parameter.

The ¹⁵N nuclear magnetic resonance (NMR) chemical shift provides another means for determining whether a secondary amino compound is “severely sterically hindered”. It has been found that the sterically hindered secondary amino compounds have a ¹⁵N NMR chemical shift greater than about δ+40 ppm, when a 90% by wt. amine solution in 10% by wt. D₂O at 35° C. is measured by a spectrometer using liquid (neat) ammonia at 25° C. as a zero reference value. Under these conditions, the tertiary amino compound used for comparison, methyldiethanolamine, has a measured ¹⁵N NMR chemical shift value of δ 27.4. For example, 2-(2-tertiarybutylamino) propoxyethanol, 3-(tertiarybutylamino)-1-propanol, 2-(2-isopropylamino)-propoxyethanol and tertiarybutylaminoethoxyethanol had measured ¹⁵N NMR chemical shift values of δ+74.3, δ+65.9, δ+65.7 and δ+60.5 ppm, respectively, whereas the ordinary sterically hindered amine, secondary-butylaminoethoxyethanol and the non-sterically hindered amine, n-butylaminoethoxyethanol had measured ¹⁵N NMR chemical shift values of δ+48.9 and δ 35.8 ppm, respectively. When the cumulative Es values is plotted against the ¹⁵N NMR chemical shift values of the amino compounds mentioned above, a straight line is observed. Amino compounds having an ¹⁵N NMR chemical shift values greater than δ+50 ppm under these test conditions had a higher H₂S selectively than those amino compounds having an ¹⁵N NMR chemical shift less than δ+50 ppm.

While hydroxyl-capped secondary and tertiary amines are preferred, capped primary alkanolamines such as monoethanolamine (MEA) are also useful and can be capped in the same way as the other alkanolamines. Aminoethers of this type are conveniently synthesized by amination of a capped alcohol or polyol in which the hydroxyl group(s) is/are replaced by amino group(s). Typically, the polyol will be a glycol; triols and higher polyols may be used for compounds with two or more capped hydroxyl groups but will not normally be preferred for reasons of economy and potential excess viscosity of the H₂S reaction (sorption) products.

The preferred capped secondary alkyloxyamines may be made by the amination process described in U.S. 2010/0037775, to which reference is made for a description of the synthesis. In this amination process a capped glycol is reacted with a primary amine to form an aminoether. For example, to produce the preferred capped alkyloxyamines, an alkyloxy glycol is aminated by reaction with a primary amine to form the desired capped secondary aminoether product. Briefly, the amination reaction is carried out in the presence of a hydrogenation catalyst, preferably a nickel under hydrogen pressure at a temperature ranging from about 160 to about 425° C., preferably from about 180 to about 400° C., and most preferably from about 190 to about 250° C. The pressure in the reactor may suitably range from about 50 to about 3000 psig, preferably from about 100 to about 1000 psig, and most preferably from about 150 to about 750 psig.

The hydrogenation catalyst used in the amination process may be platinum, palladium and other noble metals on inert supports such as carbon, silica, alumina or other refractory oxides, Raney nickel, nickel-on-kieselguhr, nickel on inert support, massive nickel or nickel-cobalt or nickel-cobalt-copper coprecipitated with silicate and/or aluminum salts having alumina or kieselguhr supports. Preferred catalysts include coprecipitated nickel, massive nickel, nickel-cobalt, and nickel-cobalt-copper supported on silica, alumina or a mixture thereof. Also preferred is platinum supported on alumina. Further details of the amination catalysts are set out in U.S. Pat. No. 7,442,840 and 2010/0037775 to which reference is made for such details

The initial alkyloxy glycol may conveniently be produced by the Williamson ether synthesis in which an alkoxide (derived in situ from the corresponding alcohol and an alkali metal hydroxide) is reacted with an alkyl halide according to the generalized scheme:

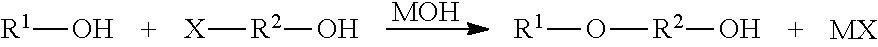

where M is the alkali metal and X is the halide, e.g., Cl, I, Br and R¹ and R² are alkyl and alkylene groups, as above. The same or an alternative ether-forming technique may be used with triols and other polyols to cap the hydroxyls as needed, leaving one or more hydroxyl groups available for amination. One alternative to the Williamson synthesis, reacts the alkanolamine with an alkyl halide, preferably bromide, but the yield tends to be limited and the reaction has the added disadvantage of producing a corrosive hydrogen halide as a by-product. Another alternative is to cap an alkanolamine directly by reaction with an alkali metal hydride although in this case, the amino group of the starting alkanolamine needs to be protected, for example, by reaction with an aldehyde such as p-anisaldehyde, with removal of the protecting group following the methylation step by hydrolysis.

The capping group used to render the hydroxyl of the starting alkoxy glycol or polyol inaccessible to carbonation by the CO₂ in the gas mixture is preferably an alkyl group, normally a short chain alkyl of 1 to 4 carbon atoms, methyl, ethyl, n-propyl, i-propyl or butyl (n-, i- or t-) so that the capped alkanolamine is a C₁-C₄ alkoxy amine.

In general terms, many of the present aminoether H₂S absorbents containing secondary amino groups are defined by the formula:

R¹—O—R²—NHR³

where R¹, R² and R³ are typically hydrocarbon or substituted hydrocarbon groups, typically alkyl or alkylene groups depending on their position in the molecule, e.g., R¹ and R³ are C₁-C₄ alkyl or C₁-C₄ substituted alkyl and R² is C₁-C₄ alkylene. It is preferred that the substituents should exclude hydroxyl in view of its reactivity with CO₂ especially under higher pressure conditions but other, non-CO₂ reactive substituent groups are acceptable, especially those polar substituents that confer enhanced water solubility when using aqueous systems. With alkanolamines which contain more than one hydroxyl group such as DEA, TEA or MDEA, the possibility of CO₂ reaction at one or more of the available hydroxyl sites obviously arises so that reaction at these sites can be inhibited to the extent that the hydroxyls are capped by conversion to alkoxy groups. Thus, with DEA, one or both hydroxyls may be converted to alkoxy, preferably methoxy, groups and with TEA, from one to three of the hydroxyls may be converted in this way. Of course, the extent to which the carbonation reaction is inhibited depends upon the proportion of the hydroxyl groups which are effectively deactivated.

Among the capped alkanolamines that may be used in the present process are the following:

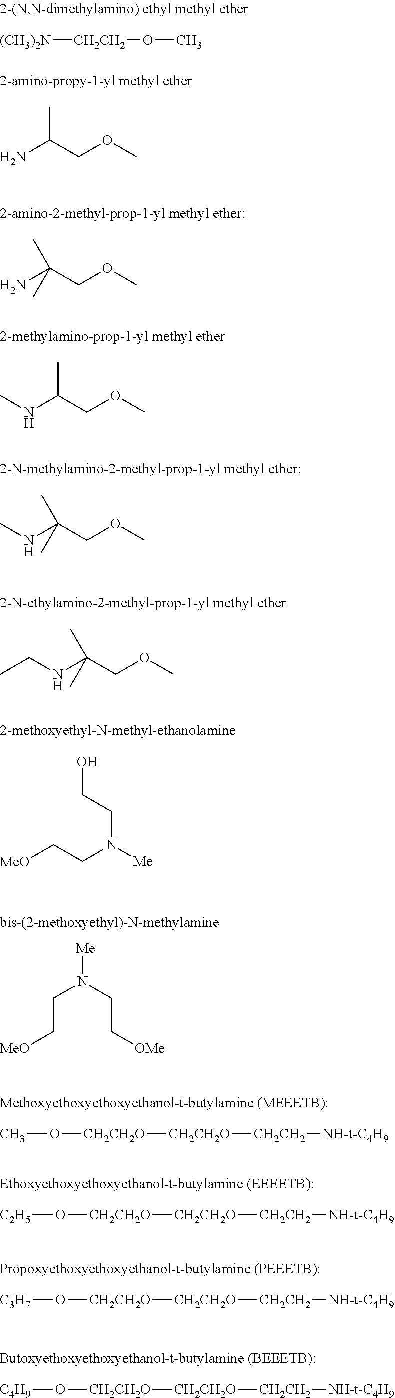

Other alternative capped secondary alkanolamines include the methoxy, ethoxy-, propoxy- and butoxy-capped ethers derived from the secondary aminothers described in U.S. Pat. No. 4,471,138, such capped ethers including the t-butylaminoethoxyethyl ethers, the 2-(2-t-butylamino)propoxyethyl ethers, the 2-(2-isopropylamino)propoxyethyl ethers, and the (1-methyl-1-ethylpropylamino)ethoxyethyl ethers.

As shown above, the amine functionality may be provided by a primary or a secondary or a tertiary amine group. Secondary amine groups provide additional steric hindrance from the two adjacent carbons than a hindered primary amine group and are generally preferred. This steric hindrance inhibits the reaction with the CO₂ at conditions approaching the hydrosulfide/CO₂ equilibrium when the kinetically faster reaction with the H₂S has taken place.

Molecular weight is a consideration in the selection of a commercially useful absorbent since sorption operates on a molecular basis but absorbents are sold on a weight basis. Low molecular weight is therefore desirable if consistent with other factors especially selectivity. This factor therefore favors the use of ethanolamine and propanolamine ethers but their molecular weight and therefore absorption capacity per unit weight will need to be balanced against their selectivity. One example of this balancing is with the tertiary amine, dimethylamino ethyl methyl ether (DMAE-OMe), which is attractive from the viewpoint of low molecular weight (103 amu); this amine forms a bicarbonate in aqueous solution, but in non-aqueous systems the tertiary amine cannot form a carbamate or a bicarbonate and is thereby free to react exclusively with H₂S. The secondary amine, 2-N-methylamino-2-methyl-prop-1-yl methyl ether (MAP-OMe) has a comparable molecular weight (115 amu) but generally has low inherent selectivity for H₂S and is therefore not favored in this application although it is effective for CO₂ separation. Thus, although the present capping procedure is effective for improving the inherent selectivity of an alkanolamine, it does not achieve high selectivity values with all alkanolamines. If high selectivity is the primary process objective to the exclusion of other considerations, the ethers of tertiary amines such as MDEA would be preferred with operation in a non-aqueous solvent: tertiary amines have no protons available for carbamate formation and in non-aqueous media cannot form bicarbonate; very good selectivities are therefore to be expected in such systems. Alternatively, more strongly basic secondary or tertiary amines of the guanidine/amidine/biguanide-type cannot react with CO₂ in non-aqueous systems to form bicarbonates and because of the larger delta in pKa, between the amine and the acid gas, there exists a driving force for faster kinetics and higher selectivities for H₂S absorption.

In the listing of exemplary capped alkanolamines above, one example of a partially capped alkanolamine is the 2-methoxyethyl-N-methyl-ethanolamine (conceptually a derivative of MDEA) which retains one hydroxyl function available for reaction with CO₂. The completely capped alkanolamine is the succeeding one, bis-(2-methoxyethyl)-N-methylamine where both hydroxyls originating from the MDEA have been capped off by methoxy functionality and thus are unable to participate in the carbonation reaction with CO₂. A similar progressive reduction in available hydroxyl functionality can be conceptualized with TEA where the hydroxyl groups might be successively converted to effect a stepwise progressive reduction in the hydroxyl functionality of the original molecule, passing from TEA to bis-(2-hydroxyethyl)-2-methoxyethyl-N-methylamine through the intermediate bis-(2-methoxyethyl)-2-hydroxyethyl-N-methylamine to the final tris-(2-hydroxyethyl)-N-methylamine.

Capped tertiary alkanolamines are also useful in the high pressure separation process; while tertiary amino alkanolamines are susceptible to reaction by carbonation on the hydroxyl groups with CO₂ under higher pressure, the capped counterparts are largely immune and so offer a path to improved H₂S selectivity. Thus, for example, etherifying the hydroxyl groups in MDEA to form bis-(methoxyethyl)-aminomethane inhibits the absorption of carbon dioxide and increases H₂S/CO₂ selectivity:

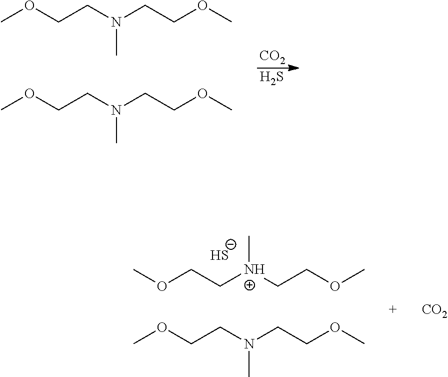

Other tertiary alkanolamines may be capped by etherification in a similar manner to improve their H2S selectivity.

### Absorbent Solvent

The cyclic absorption process is normally operated with a solvent for the absorbent in order to permit ready circulation through the unit, especially to prevent undue viscosity increases with the H₂S/capped amine reaction products in the rich solution leaving the bottom of the absorption tower. Aqueous and non-aqueous solutions may be used but while aqueous solutions may be preferred for reasons of economy, the optimal degree of H₂S selectivity will be achieved with non-aqueous solutions since certain reaction products formed with CO₂ are less stable in water and so apt to be more readily desorbed/hydrolyzed in the regeneration tower with a consequent decrease in H₂S selectivity. As indicated by the comparative testing reported below, high H₂S selectivity will be achieved by operating in non-aqueous systems and for this reason, non-aqueous solvents are normally preferred for optimum H₂S selectivity although judicious selection of the solvent on an empirical basis may become necessary especially when operating with higher molecular weight absorbents as the hydrosulfide salts formed by reaction of the H₂S at the amino nitrogen may be less soluble in non-aqueous media. Non-aqueous solvents would also be expected to be less corrosive, enabling the use of cheaper metallurgies, e.g., carbon steel, with reduced concern about corrosion at higher loadings; more polar non-aqueous solvents also minimize hydrocarbon solubility when they are evolved from natural gas wells at elevated levels.

Polar non-aqueous solvents such as toluene with a relatively low dipole moment may be found to be effective although in general, higher values for the dipole moment (Debye) of at least 2 and preferably at least 3 are to be preferred. Polar solvents such as DMSO (dimethyl sulfoxide), DMF (N,N-dimethylformamide), NMP (N-methyl-2-pyrrolidone), HMPA (hexamethylphosphoramide), THF (tetrahydrofuran) and the like are preferred from the viewpoint of potential reaction product solubility.

The preferred solvents preferably have a boiling point of at least 65° C. and preferably 70° C. or higher in order to reduce solvent losses in the process and higher boiling points are desirable depending on the regeneration conditions which are to be used. Use of higher boiling point solvents will conserve valuable energy which would otherwise be consumed in vaporization of the solvent.

Solvents potentially effective include toluene, sulfolane (tetramethylene sulfone) and dimethylsulfoxide (DMSO). Other solvents of suitable boiling point and dipole moment would include acetonitrile, N,N-dimethylformamide (DMF), tetrahydrofuran (THF), N-methyl-2-pyrrolidone (NMP), propylene carbonate, dimethyl ethers of ethylene and propylene glycols, ketones such as methyl ethyl ketone (MEK), esters such as ethyl acetate and amyl acetate, and halocarbons such as 1,2-dichlororobenzene (ODCB). Dipole moments (D) and boiling points for selected solvents are:

| | Dipole Moment, (D) | B.P., (° C.) |
|---|---|---|
| Toluene | 0.36 | 110.6 |
| Sulfolane | 4.35 | 285 |
| DMSO | 3.96 | 189 |
| DMF | 3.82 | 153 |
| MEK | 2.78 | 80 |
| Acetonitrile | 3.92 | 81 |
| THF | 1.63 | 66 |
| ODCB | 2.50 | 180.5 |

The positive effect resulting from the capping of free hydroxyl groups should be enhanced in non-aqueous systems, especially at higher pressures. Also, with regeneration at temperatures below the boiling point of water, desorption by PSA and/or TSA techniques becomes more readily attainable. The trends for selectivity, capacity and energy requirements are also favorable. If necessary, the incoming gas stream may be dried to reduce water accumulation in non-aqueous absorbent systems; for example, the incoming gas stream may be dried using conventional drying agents such as a glycol, usually diethylene glycol (DEG), triethylene glycol (TEG), propylene carbonate, or a solid dessicant such as activated alumina, granular silica gel, a small pore zeolite such as Zeolite-4A or a salt drying agent such as calcium chloride, potassium chloride, lithium chloride, sodium sulfate, or magnesium sulfate.

Both types of solvent—aqueous and non-aqueous—will, of course, tend to take up CO₂ by direct physisorption under the high pressure conditions employed; desorption under the conditions in the regeneration can be expected with some decrease in selectivity.

The concentration of the capped alkanolamines absorbent in the solvent is determined empirically in the light of the particular operational mode, the concentration of acidic gases in the incoming gas stream, the selected absorbent and the solubility of the reaction products in the selected solvent with attention also to the viscosity of the rich solution. While a high concentration of the absorbent will favor lower circulation rates and possibly smaller unit size, viscosity and solubility issues may favor less concentrated solutions. In general terms, aqueous solutions (if used) may comprise from about 30 to 70 w/w percent of the absorbent while non-aqueous solutions may require a lower concentration as a result of the trend towards lower solubility with these systems.

The concentration of the capped alkanolamine in the selected solvent can vary over a wide range. Alkanolamine concentrations may typically range from 5 or 10 weight percent to about 70 weight percent, more usually in the range of 20 to 60 weight percent. Mixtures of capped alkanolamines can be used in comparable total concentrations. The concentration of the capped alkanolamine may be optimized for specific alkanolamine/solvent mixtures in order to achieve the maximum total absorbed H₂S concentration, which typically is achieved at the highest alkanolamine concentration although a number of counter-balancing factors force the optimum to lower concentrations. Among these are limitations imposed by solution viscosity, solubilities of the alkanolamine and/or of the H₂S reaction product, and solution corrosivity. In addition, as the concentration of the capped alkanolamine affects the nature of the H₂S reaction product formed, the alkanolamine concentration also directly affects the required regeneration energy for a specific mixture. Therefore, the optimal alkanolamine concentration is selected to balance the maximum total absorbed H₂S concentration and the lowest required regeneration energy, contingent upon the viscosity, solubility and corrosivity limitations described above; this concentration is likely to vary for individual combinations and is therefore to be selected on an empirical basis which also factors in the gas feed rate relative to the rate of sorbent circulation in the unit. The temperature and pKa of the capped alkanolamine compound also play into this equation.

The formation of precipitates is regarded as generally undesirable since, if precipitates are formed, the concentration of the active amine sorbent decreases and the amount of amine available for H₂S capture, decreases accordingly. The formation of sulfide precipitates may, be exploited by separation of the solid or slurry of the solid, e.g., by hydrocyclone or centrifuge, followed by desorption of the H₂S from the solid by heating. This enables the absorbent amine to be regenerated with lower energy requirements since much less solvent needs to be stripped, heated or vaporized.

Examples 1 to 4 below illustrate the synthesis of capped alkanolamines useful as absorbents in the present process.

### Example 1

### Synthesis of 2-methoxyethyl-N-methyl-ethanolamine (MDEA-OMe)

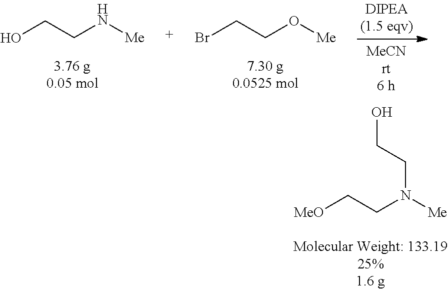 [SMILES: CNCCO ; COCCBr ; COCCN(C)CCO]

The secondary amine 2-N-methylaminoethanol (3.76 g, 0.05 mol), N,N-diisopropylethylamine (DIPEA) (6.46 g, 0.075 mol), 2-methoxyethyl bromide (7.30 g, 0.0525 mol) and 30 mL acetonitrile were placed in a round bottom flask and stirred at room temperature under nitrogen. After completion of the reaction, (˜6 h, monitored by HPLC) the reaction mixture was evaporated under reduced pressure in a rotary evaporator. The residue was dissolved in 50 mL of dichloromethane and washed with 50 mL of 50% sodium hydroxide solution in water. The aqueous layer was washed with 3×15 mL portions of dichloromethane. The collected organic fractions were dried over sodium sulfate and the solvent was then removed under reduced pressure in a rotary evaporator at low 0-5° C. to yield the crude product finally purified by fractional vacuum distillation under sodium hydroxide to yield the product (1.6 g, 0.013 mol, b.p. ˜115° C., pressure is not available) as a colorless oil in 25% yield.

2-methoxyethyl-N-methyl-ethanolamine (MDEA-OMe), a colorless oil, was collected in a yield of 25%. ¹H NMR (300 MHz, CDCl₃) δ 3.63-3.56 (m, 2H), 3.48 (t, J=5.6 Hz, 2H), 3.36 (s, 3H), 2.93 (s, 1H), 2.64 (t, J=5.6 Hz, 2H), 2.61-2.55 (m, 2H), 2.33 (s, 3H). ¹³C NMR (75 MHz, CDCl₃) δ 70.8, 59.0, 58.9, 58.9, 56.7, 42.8.

### Example 2

### Synthesis of bis-(2-methoxyethyl)-N-methylamine (MDEA-(OMe)₂)

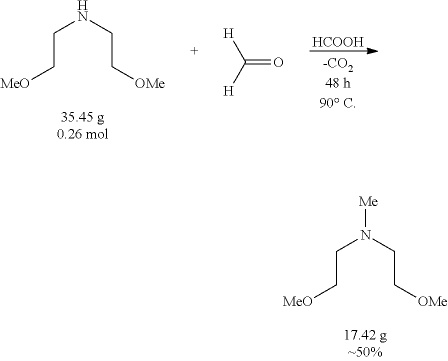 [SMILES: COCCNCCOC ; C=O ; "HCOOH" ; COCCN(C)CCOC]

Bis(2-methoxyethyl)amine (35.45 g, 0.26 mol) was cooled to 0° C. in a 2-L round-bottom flask containing a stir bar. Following dropwise addition of 88% aqueous formic acid (47 mL, 0.91 mol), 37% aqueous formaldehyde (56 mL, 0.69 mol) was added. Controlled heating to 60° C. initiated rapid gas evolution. The reaction was allowed to proceed without further heating until gas evolution decreased (˜6 h) and was then heated to 80° C. for 24 h. The reaction mixture was cooled, acidified with 20% aqueous HCl, and extracted three times with 100 mL portions of diethyl ether. The aqueous layer was stirred in a salt/ice bath and brought to pH 12 by dropwise addition of 40% aqueous NaOH without allowing the internal temperature to exceed 25° C. Following separation of the resulting amine/aqueous layers, the aqueous layer was further extracted three times with 100 mL portions of diethyl ether. The combined organic layers were dried over sodium sulfate and solvent rotary evaporated under reduced pressure at low temperature. The resulting crude product was subjected to fractional vacuum distillation under sodium hydroxide to yield the product (17.42 g, 0.13 mol, b.p. 120-122° C., 35 Torr) as a colorless oil in 50% yield.

Bis-(2-methoxyethyl)-N-methylamine (MDEA-(OMe)₂), a colorless oil, was collected in a yield of 50%. ¹H NMR (300 MHz, CDCl₃) δ3.44 (t, J=5.8 Hz, 4H), 3.29 (s, 6H), 2.57 (t, J=5.8 Hz, 4H), 2.27 (s, 3H). ¹³C NMR (75 MHz, CDCl₃) δ 70.7, 58.8, 57.2, 43.2.

### Example 3

### General procedures for 2-methyl-3-methoxy-2-propylamine (AP-OMe) and 2,2-dimethyl-3-methoxy-2-propylamine (AMP-OMe) syntheses

This Example demonstrates the synthesis of two alkoxy propylamine derivatives in a three stage synthesis in which the amino group on an initial propanolamine compound is first protected by p-methoxyphenyl protection (PMP-protection) to form a protected aminoalcohol which is then methylated on the hydroxyl group after which the protecting PMP group is removed to form the final methoxy substituted amine.

Step 1 p-Methoxyphenyl Protection (PMP-Protection)

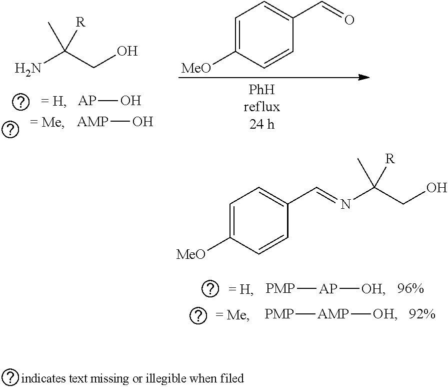

A mixture of the selected amino alcohol (1 eq) and p-anisaldehyde (1.1 eq) was heated under reflux in benzene with azeotropic removal of water during 24 hours. The reaction was concentrated under reduced pressure. The desired products were recrystallized from hexane.

PMP-AP-OH, was collected as white microcrystals in a yield of 96%. ¹H NMR (300 MHz, CDCl₃) δ 8.09 (s, 1H), 7.53 (d, J=8.7 Hz, 2H), 6.80 (d, J=8.7 Hz, 2H), 3.74 (s, 3H), 3.69-3.49 (m, 1H), 3.48-3.27 (m, 2H), 1.10 (d, J=6.5 Hz, 3H). ¹³C NMR (75 MHz, CDCl₃) δ 161.57, 160.86, 129.90, 128.75, 113.83, 67.61, 67.18, 55.32, 18.48.

PMP-AMP-OH was collected as white microcrystals in a yield of 92%, mp 52-53° C. (hexane). ¹H NMR (300 MHz, CDCl₃) δ 8.24 (s, 1H), 7.67 (d, J=8.7 Hz, 2H), 7.39 (d, J=8.4 Hz, 2H), 6.90 (t, J=8.6 Hz, 4H), 5.49 (s, 1H), 3.82 (s, 3H), 3.79 (s, 3H), 3.70 (d, J=7.5 Hz, 1H), 3.56 (d, J=7.4 Hz, 1H), 3.50 (s, 2H), 1.30 (s, 6H), 1.23 (s, 6H). ¹³C NMR (75 MHz, CDCl₃) δ 161.6, 159.7, 156.9, 132.0, 129.6, 128.4, 127.2, 114.0, 113.8, 91.9, 77.9, 71.9, 60.4, 59.9, 55.3, 26.9, 26.3, 24.1.

### Step 2 Methylation of PMP-Protected Amino Alcohols

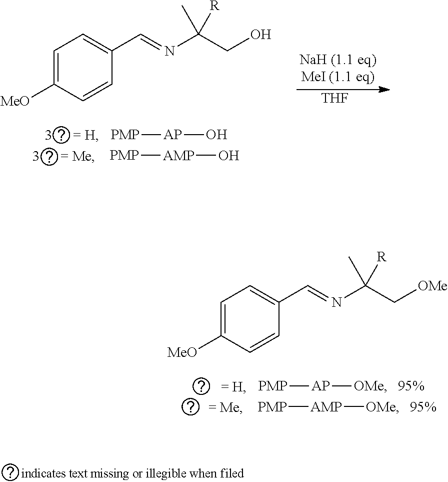

The PMP-protected amino alcohol (1 eq) was reacted with sodium hydride (60% in mineral oil, 1.1 eq) in dry THF at 0° C. After 4 h stirring at room temperature, methyl iodide (1.1 eq) was added by dropwise to the reaction mixture. The resulting mixture was stirred at room temperature for 12 h. The reaction was quenched in water and extracted with dichloromethane. The organic layer was dried over sodium sulfate, filtered and concentrated under reduced pressure in rotary evaporator to give the desired methoxy ether of the initial PMP-protected amino alcohol.

PMP-AP-OMe, yield 95%, yellow oil. ¹H NMR (300 MHz, CDCl₃) δ 8.23 (s, 1H), 7.67 (d, J=8.7 Hz, 2H), 6.89 (d, J=8.6 Hz, 2H), 3.80 (s, 3H), 3.60-3.06 (m, 6H), 1.22 (d, J=6.0 Hz, 3H). ¹³C NMR (75 MHz, CDCl₃) δ 161.49, 159.81, 129.77, 129.26, 113.71, 77.58, 65.70, 59.01, 55.31, 19.08.

PMP-AMP-OMe, yield 95%, yellow oil. ¹H NMR (300 MHz, CDCl₃) δ 8.24 (s, 1H), 7.69 (d, J=8.9 Hz, 2H), 6.90 (d, J=8.9 Hz, 2H), 3.82 (s, 3H), 3.36 (m, 5H), 1.26 (s, 6H). ¹³C NMR (75 MHz, CDCl₃) δ 161.4, 156.4, 130.1, 129.6, 113.9, 81.6, 60.2, 59.6, 55.4, 24.7.

### Step 3 PMP-Deprotection

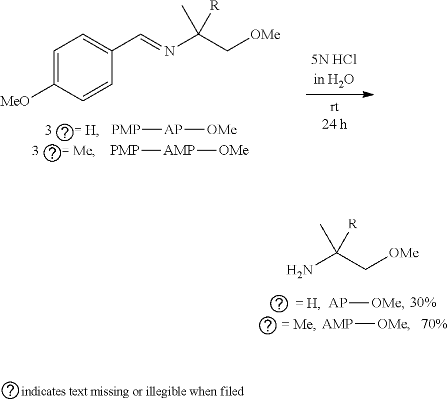

The methoxy ether of the PMP-protected amino alcohol was stirred 24 h in 250 mL of 5 N hydrochloric acid solution in water at room temperature. The reaction mixture was then washed with 3×75 mL portions of diethyl ether to extract p-anisaldehyde. The aqueous layer was stirred in a salt/ice bath and brought to pH 12 by dropwise addition of 40% aqueous NaOH without allowing the internal temperature to exceed 25° C., then was further extracted three times with 100 mL portions of diethyl ether. The combined organic layers were dried over sodium sulfate and the solvent was evaporated under reduced pressure at low temperature. The resulting crude product was subjected to fractional distillation under sodium hydroxide (bp of AMP-OMe ˜98-101° C.; AP-OMe ˜95-98° C.) at atmospheric pressure.

AP-OMe (308), yield 30%, colorless oil. ¹H NMR (300 MHz, CDCl₃) δ 3.35 (s, 3H), 3.27 (m, 1H), 3.19-3.03 (m, 2H), 1.03 (d, J=5.9 Hz, 3H). ¹³C NMR (75 MHz, CDCl₃) δ 79.27, 58.31, 45.91, 19.34.

AMP-OMe, yield 70%, colorless oil. ¹H NMR (300 MHz, CDCl₃) δ 3.37 (s, 3H), 3.12 (s, 2H), 1.09 (s, 6H). ¹³C NMR (75 MHz, CDCl₃) δ 82.9, 58.9, 49.7, 27.1.

### Example 4

### General procedure for 2-methyl-2-methylamino-prop-1-yl methyl ether (MAP-OMe) and 2,2-dimethyl-2-methylamino-prop-1-yl methyl ether (MAMP-OMe) syntheses

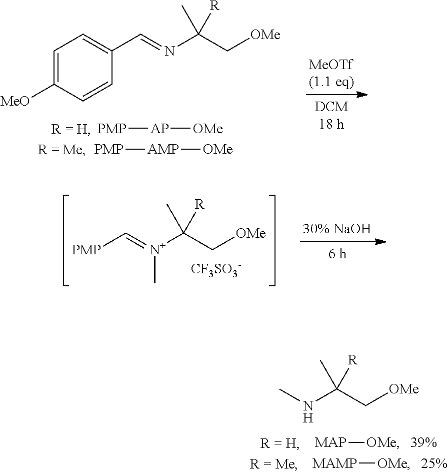

The methoxy ether of PMP-protected amino alcohol (1 eq) was reacted with methyl triflate (1.1 eq) in dichloromethane under reflux to form the iminium salt in (monitored by ¹H NMR) which was hydrolyzed with 100 mL of sodium hydroxide as 30% solution in water during 1 h at 20° C. The desired product was extracted with dichloromethane (2×100 ml) then dried under sodium sulfate followed by fractional distillation under sodium hydroxide at atmospheric pressure (bp of MAP-OMe ˜102-106° C.; MAMP-OMe ˜105-110° C.).

MAP-OMe, yield 39%, colorless oil. ¹H NMR (300 MHz, CDCl₃) δ 3.44-3.14 (m, 5H), 2.90-2.61 (m, 1H), 2.42 (s, 3H), 1.01 (d, J=6.4 Hz, 3H). ¹³C NMR (75 MHz, CDCl₃) δ 76.94, 58.72, 54.20, 33.71, 16.34.

MAMP-OMe, yield 25%, colorless oil. ¹H NMR (300 MHz, CDCl₃) δ 1.03 (s, 6H), 2.29 (s, 3H), 3.18 (s, 2H), 3.36 (s, 3H). ¹³C NMR (75 MHz, CDCl₃) δ 23.3, 28.4, 52.8, 59.1, 9.1.

Examples 5 to 13 below illustrate the extent to which capped and uncapped alkanolamines differ in their ability to react with CO₂ in aqueous and non-aqueous solvents. The experiments were run as single component uptake experiments with CO₂ only (which reacts with amine and —OH) in order to confirm CO₂ uptake via O-carbonation of alkanolamines and absence of O-carbonation of methoxylated amines. In the presence of H₂S, methoxylated amines will react preferentially with the H₂S rather than with CO₂ under conditions short of equilibrium between the two absorbing species (i.e. with short contact times) because the amino group tends to react faster with H₂S and the methoxy group is no longer reactive towards the CO₂.

### General Procedure for Acid Gas Uptake and Desorption

The experimental setup for monitoring of amine acid gas uptake by was built inside a wide bore 400 MHz Bruker Avance™ nuclear magnetic resonance (NMR) spectrometer equipped with variable temperature capabilities. A 10 mm NMR tube placed inside the instrument and containing a solution of the desired amine, typically in H₂O or d6-dimethylsulfoxide (DMSO-d6), was contacted with an acid gas, e.g., CO₂ at desired pressure inside the instrument while recording quantitative ¹H and ¹³C{1H} NMR spectra. Desorption/regeneration experiments were performed by decreasing the CO₂ pressure and increasing the solution temperature if needed.

¹³C and ¹H spectra taken before, during, and after the absorption/desorption sequence(s) gave quantitative information about the starting solution, reaction kinetics, and intermediate/final sorption products. The reaction products seen in ¹³C NMR spectra were identified and quantified by integration of the ¹³C NMR carbonyl resonance(s) at 165-164 ppm (representing CO₂ as an ammonium carbamate), 161-160 ppm (representing CO₂ as an ammonium bicarbonate), 159-158 ppm (representing CO₂ in O-carbonate) versus resonances representing the amine —OCH₂CH₂N— and (if present) —NCH₃ groups. Carbon dioxide dissolved in solution was detected at 125-124 ppm and accounted for as additional gas uptake. When desired, samples were transferred into a 5 mm NMR tube for more accurate ex-situ 10 and 2D NMR analysis on a Bruker Avance III™ narrow bore 400 MHz spectrometer.

### Example 5

### Reaction of CO₂ with MeO-MAMP in DMSO

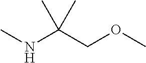

The severely hindered secondary amine 2-N-methylamino-2-methylprop-1-yl methyl ether which has a methyl capped hydroxyl group was studied as an example of a compound, which does not react with CO₂ but reacts with H₂S in non-aqueous solution. The presence of the methoxy group also prevents an additional CO₂ reaction with the hydroxyloxygen of the alkanolamine via an O-carbonation reaction. Such severely hindered amines such as MeO-MAMP in anhydrous solution can be used for very efficient separation of CO₂/H₂S based on fast reaction rates of an amine with H₂S and of the slower CO₂ reaction with the amine because of its steric hindrance.

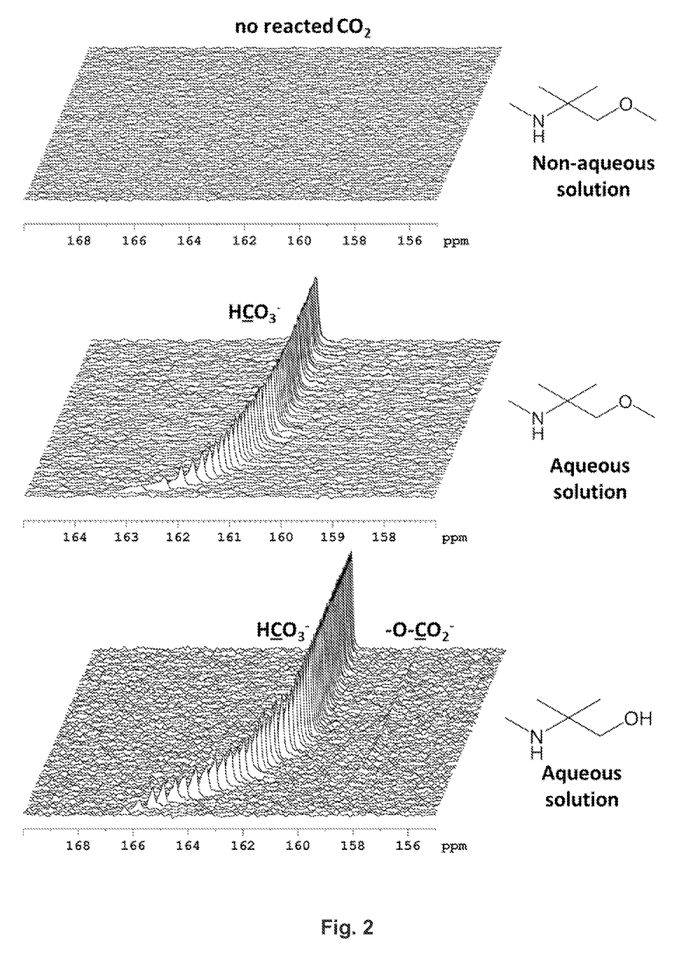

FIG. 2 (top) shows the evolution of the ¹³C NMR spectra of 1-methoxy-2-N-methylamino-2-methylpropan-1-ol as a 3 molar solution in DMSO-d6 during the reaction with CO₂ at 10.0 bar and 45° C. As CO₂ was introduced into the amine solution at 45° C., no new peaks were observed in the carbonyl region at 168-160 ppm during 16 hours of an experiment (FIG. 2, top) indicating that the hindered secondary amine group does not react with CO₂ in anhydrous solution. O-carbonation reaction products in the region 159-158 ppm were not observed as well (see FIG. 2, top). However, CO₂ was dissolved in the solution at experimental conditions and detected at 125.5 ppm by ¹³C NMR. The amount of dissolved CO₂ can be reduced by using another anhydrous solvent such as toluene, sulfolane etc.

### Example 6

### Reaction of CO₂ with MeO-MAMP in H₂O

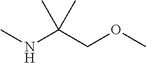

The severely hindered secondary amine with a methyl capped hydroxyl group, 2-N-methylamino-2-methylprop-1-yl methyl ether (MeO-MAMP), was studied as an example of compound with slow CO₂ reaction rates with the amine in aqueous solution. The methoxy-group of MeO-MAMP also prevents an additional CO₂ reaction with the hydroxyloxygen of the amine. Severely hindered amines with capped hydroxyl groups such as MeO-MAMP can be used for kinetic separation of CO₂/H₂S based on fast reaction rates of an amine with H₂S and slow reaction rates with CO₂.

FIG. 2 (middle) shows the evolution of the ¹³C NMR spectra of 2-N-methylamino-2-methylprop-1-yl methyl ether as a 3 molar solution in H₂O during the reaction with CO₂ at 10.0 bar and 45° C. As CO₂ was introduced into the amine solution at 45° C., one peak appeared in the carbonyl region at ˜163 ppm corresponding to initial formation of carbonate and bicarbonate species in equilibrium; with increasing reaction time (from the bottom to the top of the graph), this gradually shifted to 160.6 ppm at saturation as shown in FIG. 2 (middle). For a system in which 100% of the captured CO₂ is present in bicarbonate form, the theoretical maximum uptake is 1.0 mole of CO₂ per amine group. The amine backbone carbons showed sensitivity to the formation of the (bi)carbonate, shifting slightly upheld (consistent with protonation to an ammonium species) while maintaining a simple four-peak structure indicating clean formation of only one product type. O-carbonation reaction products in the region 159-158 ppm were not observed (see FIG. 2, middle). However, a small amount of CO₂ was dissolved in the solution at experimental conditions and detected at 125.0 ppm by ¹³C NMR. The final CO2 loading at equilibrium is 1.08 CO₂ per amine.

Unlike regular nucleophilic primary and secondary amines such as monoethanolamine (MEA) and N-methylaminoethanol (MAE), the hindered secondary amine MeO-MAMP does not form a carbamate reaction product with CO₂ and directly forms bicarbonate/carbonate species. This reaction mechanism is characterized by a very long reaction constant characteristic of tertiary amines such as dimethylaminoethanol (DMAE) or triethanolamine (TEA) where the rate constant for direct bicarbonate formation with CO₂ is 10-100 times lower.

### Example 7

### Reaction of CO₂ with MAMP in H₂O (Comparative)

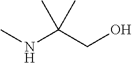

The severely hindered secondary alkanolamine, 2-methylamino-2-methylpropan-1-ol (MAMP), was studied as a comparative example of a compound with slow CO₂ reaction rates with an amine in aqueous solution. In contrast to MeO-MAMP with a methoxy-group, the hydroxyl group of MAMP is responsible for additional CO₂ reaction with the hydroxyloxygen of an alkanolamine, which increase CO₂ loading and decreases CO₂/H₂S separation efficiency.

FIG. 2 (bottom) shows the evolution of the ¹³C NMR spectra of MAMP as a 3 molar solution in H₂O during the reaction with CO₂ at 10.0 bar and 45° C. As CO₂ was introduced into the amine solution at 45° C., one peak appeared in the carbonyl region at ˜166 ppm corresponding to initial formation of carbonate and bicarbonate species in equilibrium; with increasing reaction time (from the bottom to the top of the graph), this gradually shifted to 160.6 ppm at saturation as shown in FIG. 2 (bottom). This peak represents bicarbonate species with an equilibrium loading of 0.96 CO₂ per amine. O-carbonation reaction products were also detected at 158.2 ppm with an equilibrium loading 0.04 CO₂ per amine. No dissolved CO₂ was detected by ¹³C NMR. The final CO₂ loading at equilibrium is 1.00 CO₂ per amine.

### Example 8

### Reaction of CO₂ with MDEA-(MeO)₂ in DMSO

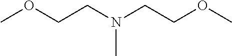

The severely hindered secondary amine with methyl capped hydroxyl groups, bis-(2-methoxyethyl)-N-methylamine (2-MDEA-(OMe)₂) was studied as an example of a compound, which does not react with CO₂ but reacts with H₂S in non-aqueous solution. The methoxy-groups of MDEA-(OMe)₂ also prevent an additional CO₂ reaction with the hydroxyloxygen of the amine via an O-carbonation reaction. Tertiary amines such as MDEA-(OMe)₂ in anhydrous solution can be used for very efficient separation of CO₂/H₂S based on fast reaction rates of the amine with H₂S and the slower CO₂ reaction with the amine.

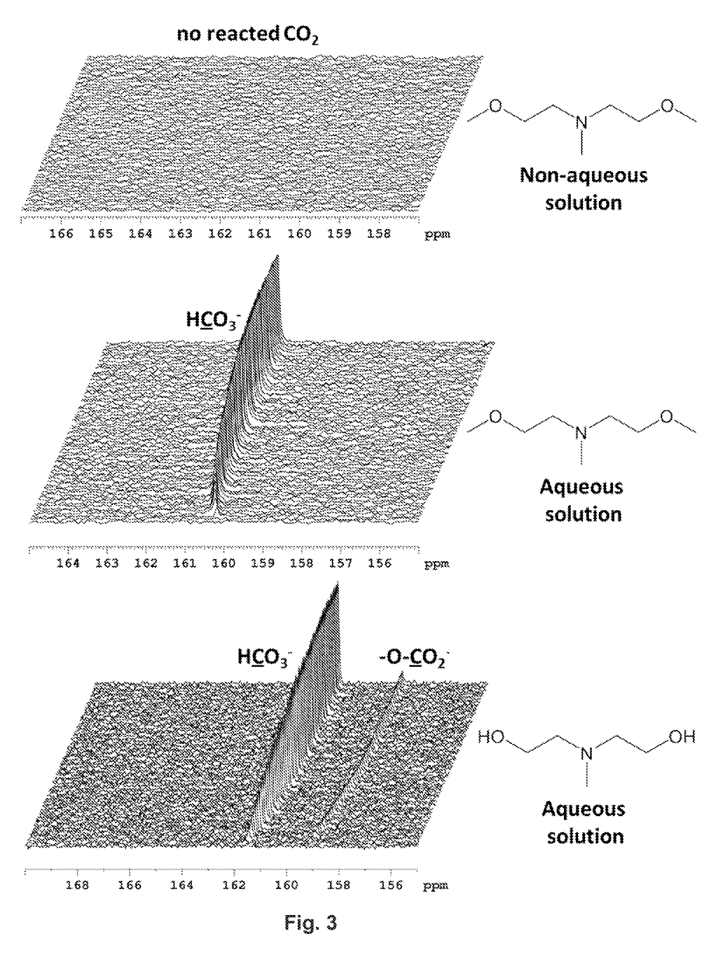

FIG. 3 (top) shows the evolution of the ¹³C NMR spectra of MDEA-(OMe)₂ as a 3 molar solution in DMSO-d6 during the reaction with CO₂ at 10.0 bar and 45° C. As CO₂ was introduced into the amine solution at 45° C., no new peaks were observed in the carbonyl region at 168-160 ppm during 16 hours of an experiment (FIG. 3, top) indicating that the secondary amine of MDEA-(OMe)₂ does not react with CO₂ in anhydrous solution. O-carbonation reaction products in the region 159-158 ppm were not observed as well (see FIG. 3, top). However, CO₂ was dissolved in the solution at experimental conditions and detected at 125.5 ppm by ¹³C NMR. The amount of dissolved CO₂ can be reduced by using another anhydrous solvent such as toluene, sulfolane etc.

### Example 9

### Reaction of CO₂ with MDEA-(MeO)₂ in H₂O

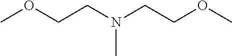

The tertiary amine MDEA-(OMe)₂ with capped hydroxyl groups was studied as an example of a compound with slow CO₂ reaction rates with an amine in aqueous solution. The methoxy-groups of MDEA-(OMe)₂ prevent an additional CO₂ reaction with the hydroxyloxygen of an amine. Tertiary amines with capped hydroxyl groups such as MDEA-(OMe)₂ can be used for kinetic separation of CO₂/H₂S based on fast reaction rates of an amine with H₂S and slow reaction rates with CO₂.

FIG. 3 (middle) shows the evolution of the ¹³C NMR spectra of MDEA-(OMe)₂ as a 3 molar solution in H₂O during the reaction with CO₂ at 10.0 bar and 45° C. As CO₂ was introduced into the amine solution at 45° C., one peak appeared in the carbonyl region at ˜160 ppm corresponding to initial formation of bicarbonate species; with increasing reaction time (from the bottom to the top of the graph), this gradually shifted to 160.6 ppm at saturation as shown in FIG. 3 (middle). O-carbonation reaction products in the region 159-158 ppm were not observed (see FIG. 3, middle). However, small amount of CO₂ was dissolved in the solution at experimental conditions and detected at 125.0 ppm by ¹³C NMR. The final CO₂ loading at equilibrium is 0.81 CO₂ per amine (0.76 as an ammonium bicarbonate and 0.05 dissolved CO₂).

Unlike regular nucleophilic primary and secondary amines such as monoethanolamine (MEA) and N-methylaminoethanol (MAE), tertiary amine MDEA-(OMe)₂ does not form a carbamate reaction product with CO₂ and directly forms bicarbonate/carbonate species. This reaction mechanism is characterized by a very long reaction constant. The rate constant for direct bicarbonate formation of tertiary or severely hindered amines with CO₂ is 10-100 times lower.

### Example 10

### Reaction of CO₂ with MDEA in H₂O (Comparative)

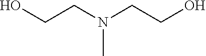

The tertiary alkanolamine, methyldiethanolamine (MDEA), was studied as a comparative example because it is used commercially for H₂S/CO₂ separation. In contrast to MDEA-(OMe)₂, the hydroxyl groups of MDEA are available for additional CO₂ reaction which increases CO₂ loading and decreases CO₂/H₂S separation efficiency.

FIG. 3 (bottom) shows the evolution of the ¹³C NMR spectra of MDEA as a 3 molar solution in H2O during the reaction with CO₂ at 10.0 bar and 45° C. As CO₂ was introduced into the amine solution at 45° C., one peak appeared in the carbonyl region at ˜162 ppm corresponding to initial formation of carbonate and bicarbonate species in equilibrium; with increasing reaction time (from the bottom to the top of the graph), this gradually shifted to 160.8 ppm at saturation as shown in FIG. 3 (bottom). This peak represents bicarbonate species with an equilibrium loading of 0.69 CO₂ per amine. O-carbonation reaction products at high concentration were also detected at 158.3 ppm with equilibrium loading of 0.15 CO₂ per amine. No dissolved CO₂ was detected by ¹³C NMR. The final CO₂ loading at equilibrium is 0.84 CO₂ per amine. The formation of significant quantities of O-carbonation product results in a decreased selectivity for H₂S vs CO₂ absorption from gas mixtures.

### Example 11

### Reaction of CO₂ with MeO-AMP in DMSO

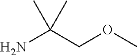

The severely hindered primary amine 2-amino-2-methylprop-1-yl methyl ether which has a methyl capped hydroxyl group, was studied as an example of a compound, which reacts with CO₂ slowly in non-aqueous solution while reaction with H₂S is expected significantly faster. The presence of the methoxy group also prevents an additional CO₂ reaction with the hydroxyloxygen of the alkanolamine via an O-carbonation reaction. Such severely hindered amines such as MeO-AMP in anhydrous solution can be used for very efficient separation of CO₂/H₂S based on fast reaction rates of an amine with H₂S and of the slower CO₂ reaction with the amine because of its steric hindrance.

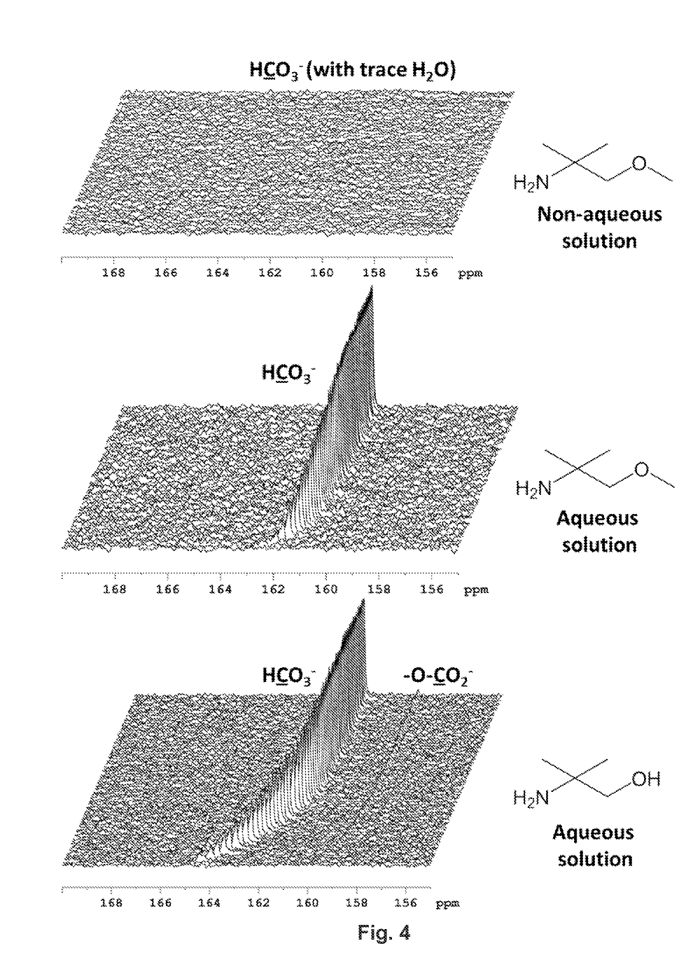

FIG. 4 (top) shows the evolution of the ¹³C NMR spectra of 2-amino-2-methylprop-1-yl methyl ether as a 3 molar solution in DMSO-d6 during the reaction with CO₂ at 10.0 bar and 45° C. As CO₂ was introduced into the amine solution at 45° C., new broad peak was observed in the carbonyl region at 160.1 ppm representing bicarbonate species formed with trace amount of water in the solution (presence of water was confirmed by ¹H NMR). With increasing reaction time (from the bottom to the top of the graph), intensity of this peak gradually increased to achieve the CO₂ loading approximately 0.46 CO₂ per amine. In pure non-aqueous solution, no reaction of MeO-AMP with CO₂ is expected.

O-carbonation reaction products in the region 159-158 ppm were not observed as well (see FIG. 4, top). However, CO₂ was dissolved in the solution at experimental conditions and detected at 125.5 ppm by ¹³C NMR. The amount of dissolved CO₂ can be reduced by using another anhydrous solvent such as toluene, sulfolane etc.

### Example 12

### Reaction of CO₂ with MeO-AMP in H₂O

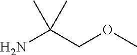

The severely hindered primary amine with a methyl capped hydroxyl group, 2-amino-2-methylprop-1-yl methyl ether (MeO-AMP), was studied as an example of compound with slow CO₂ reaction rates with the amine in aqueous solution. The methoxy-group of MeO-AMP also prevents an additional CO₂ reaction with the hydroxyloxygen of the amine. Severely hindered amines with capped hydroxyl groups such as MeO-AMP can be used for kinetic separation of CO₂/H₂S based on fast reaction rates of an amine with H₂₅ and slow reaction rates with CO2.

FIG. 4 (middle) shows the evolution of the ¹³C NMR spectra of 2-amino-2-methylprop-1-yl methyl ether as a 3 molar solution in H₂O during the reaction with CO₂ at 10.0 bar and 45° C. As CO₂ was introduced into the amine solution at 45° C., one sharp peak appeared in the carbonyl region at ˜162 ppm corresponding to initial formation of carbonate and bicarbonate species in equilibrium; with increasing reaction time (from the bottom to the top of the graph), this gradually shifted to 160.6 ppm at saturation as shown in FIG. 4 (middle). For a system in which 100% of the captured CO₂ is present in bicarbonate form, the theoretical maximum uptake is 1.0 mole of CO₂ per amine group. The amine backbone carbons showed sensitivity to the formation of the (bi)carbonate, shifting slightly upheld (consistent with protonation to an ammonium species) while maintaining a simple four-peak structure indicating clean formation of only one product type. O-carbonation reaction products in the region 159-158 ppm were not observed (see FIG. 4, middle). However, a small amount of CO₂ was dissolved in the solution at experimental conditions and detected at 125.0 ppm by ¹³C NMR. The final CO₂ loading at equilibrium is 1.06 CO₂ per amine.

### Example 13

### Reaction of CO₂ with AMP in H₂O (Comparative)

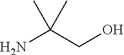

The severely hindered primary alkanolamine, 2-amino-2-methylpropan-1-ol (AMP), was studied as a comparative example of a compound with slow CO₂ reaction rates with an amine in aqueous solution. In contrast to MeO-AMP with a methoxy-group, the hydroxyl group of AMP is responsible for additional CO₂ reaction with the hydroxyloxygen of an alkanolamine, which increase CO₂ loading and decreases CO₂/H₂S separation efficiency.

FIG. 4 (bottom) shows the evolution of the ¹³C NMR spectra of AMP as a 3 molar solution in H₂O during the reaction with CO₂ at 10.0 bar and 45° C. As CO₂ was introduced into the amine solution at 45° C., one peak appeared in the carbonyl region at ˜165 ppm corresponding to initial formation of carbonate and bicarbonate species in equilibrium; with increasing reaction time (from the bottom to the top of the graph), this gradually shifted to 160.7 ppm at saturation as shown in FIG. 4 (bottom). This peak represents bicarbonate species with an equilibrium loading of 0.97 CO₂ per amine. O-carbonation reaction products were also detected at 158.5 ppm with an equilibrium loading 0.03 CO₂ per amine. No dissolved CO₂ was detected by ¹³C NMR. The final CO₂ loading at equilibrium is 1.00 CO₂ per amine.

### Example 14

### Reaction of CO₂ with MeO-MAP in H₂O (Comparative)

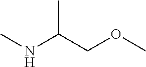

The moderately hindered secondary amine with a methyl capped hydroxyl group, 2-N-methylamino-prop-1-yl methyl ether (MeO-MAP), was studied as an example of compound with fast CO₂ reaction rates with the amine in aqueous solution. The methoxy-group of MeO-MAP prevents an additional CO₂ reaction with the hydroxyloxygen of the amine but helps to maintain solution viscosity. Moderately hindered amines with capped hydroxyl groups such as MeO-MAP cannot be used for kinetic separation of CO₂/H₂S based because reaction rates of H₂S and CO₂ with an amine are similar. However, moderately hindered secondary amines with capped hydroxyl groups such as MeO-MAP can be utilized for effective CO₂ capture from various gases such as flue gas and natural gas

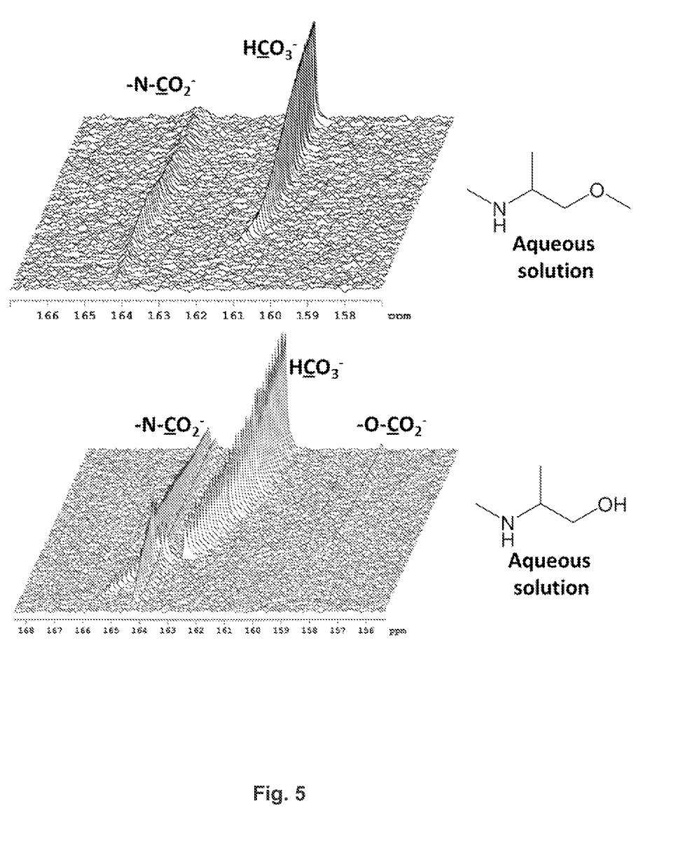

FIG. 5 (top) shows the evolution of the ¹³C NMR spectra of 2-N-methylamino-2-prop-1-yl methyl ether as a 5 molar solution in H₂O during the reaction with CO₂ at 1.0 bar and 45° C. As CO₂ was introduced into the amine solution at 45° C., one sharp peak appeared in the carbonyl region at ˜164 ppm corresponding to initial formation of carbamate species; with increasing reaction time (from the bottom to the top of the graph), intensity of this peak gradually increased and the second peak appeared in the carbonyl region at ˜161 ppm corresponding to formation of bicarbonate species as shown in FIG. 5 (top). The amine backbone carbons showed sensitivity to the formation of the carbamate and bicarbonate, shifting slightly upfield (consistent with protonation to an ammonium species) and splitting (indicating carbamate anions and cations). O-carbonation reaction products in the region 159-158 ppm were not observed (see FIG. 5, top). Dissolved in the solution CO₂ was not detected by ¹³C NMR at experimental conditions (CO₂ at 1.0 bar and 45° C.). The equilibrium CO₂ loading is 0.72 CO₂ per amine with 0.19 CO₂ per amine in carbamate and 0.52 CO₂ per amine in bicarbonate.

At 10.0 bar of CO₂ and 45° C., carbamate completely hydrolyzed into bicarbonate (not shown here). The equilibrium CO₂ loading at given conditions is 1.00 CO₂ per amine with all CO₂ molecules present in bicarbonate. O-carbonation and dissolved CO2 was not detected by ¹³C NMR.

### Example 15

### Reaction of CO₂ with MAP in H₂O (Comparative)

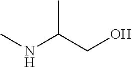

The moderately hindered secondary alkanolamine, 2-N-methylamino-propan-1-ol (MAP), was studied as an example of compound with fast CO₂ reaction rates with the amine in aqueous solution. In contrast to MeO-MAP with a methoxy-group, the hydroxyl group of MAP is responsible for additional CO₂ reaction with the hydroxyloxygen of an alkanolamine, which increase CO₂ loading. Moderately hindered alkanolamines such as MAP cannot be used for kinetic separation of CO₂/H₂S based because reaction rates of H₂S and CO₂ with an amine are similar. However, moderately hindered secondary alkanolamines such as MAP can be utilized for effective CO₂ capture from various gases such as flue gas and natural gas

FIG. 5 (bottom) shows the evolution of the ¹³C NMR spectra of 2-N-methylamino-2-propan-1-ol as a 5 molar solution in H₂O during the reaction with CO₂ at 0.5 bar and 30° C. As CO₂ was introduced into the amine solution at 30° C., one sharp peak appeared in the carbonyl region at ˜164 ppm corresponding to initial formation of carbamate species; with increasing reaction time (from the bottom to the top of the graph), intensity of this peak gradually increased. The second peak appeared in the carbonyl region at ˜166 ppm corresponding to formation of carbonate and bicarbonate species in equilibrium as shown in FIG. 5 (top). With increasing reaction time, this peak increased and shifted to 160.0 ppm corresponding to formation of bicarbonate reaction products. The amine backbone carbons showed sensitivity to the formation of the carbamate and bicarbonate, shifting slightly upfield (consistent with protonation to an ammonium species) and splitting (indicating carbamate anions and cations). O-carbonation reaction product was also detected at 158.0 ppm (see FIG. 5, bottom). Dissolved in the solution CO₂ was not detected by ¹³C NMR at experimental conditions (CO₂ at 0.5 bar and 30° C.). The equilibrium CO₂ loading is 0.79 CO₂ per amine with 0.20 CO₂ per amine in carbamate, 0.57 CO₂ per amine in bicarbonate, and 0.02 CO₂ per amine in O-carbonate.

At 10.0 bar of CO₂ and 30° C., carbamate completely hydrolyzed into bicarbonate. The equilibrium CO₂ loading at given conditions is 1.00 CO₂ per amine with all CO₂ molecules present in bicarbonate. The equilibrium CO₂ loading and the contribution of reaction products for the alkanolamines and amino-ethers tested in Examples 5 to 13 are summarized in Table 1 together with the results of testing the uncapped alkanolamines in aqueous solution with product speciation as CO₂/amine molecule) at 10.0 bar of CO₂ and 45° C. in aqueous and non-aqueous solution. Use of non-aqueous solvent and capping of the hydroxyl group(s) of an alkanolamine leaves the amine nitrogen free to preferentially react with hydrogen sulfide.

TABLE 1
Summary of CO₂ uptake by representative alkanolamines and amino-ethers

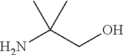

aqueous solution
(AMP)

| carbamate | — |
|---|---|
| bicarbonate | 0.97 |
| O—carbonate | 0.03 |
| dissolved | — |
| TOTAL | 1.00 |

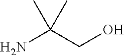

non-aqueous solution

| | |
|---|---|
| carbamate | — |
| bicarbonate | 0.42* |
| O—carbonate | 0.10 |
| dissolved | 0.14 |
| TOTAL | 0.64 |

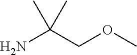

aqueous solution

| | |
|---|---|
| carbamate | — |
| bicarbonate | 1.01 |
| O—carbonate | — |
| dissolved | 0.05 |
| TOTAL | 1.06 |

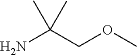

non-aqueous solution

| | |
|---|---|
| carbamate | — |
| bicarbonate | 0.46* |
| O—carbonate | — |
| dissolved | 0.22 |
| TOTAL | 0.68 |

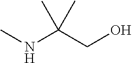

aqueous solution
(MAMP)

| | |
|---|---|
| carbamate | — |
| bicarbonate | 0.96 |
| O—carbonate | 0.04 |
| dissolved | 0.03 |
| TOTAL | 1.03 |

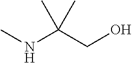

non-aqueous solution

| | |
|---|---|
| carbamate | — |
| bicarbonate | 0.37* |
| O—carbonate | 0.19 |
| dissolved | 0.22 |
| TOTAL | 0.78 |

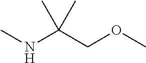

aqueous solution

| | |
|---|---|
| carbamate | — |
| bicarbonate | 1.04 |
| O—carbonate | — |
| dissolved | 0.04 |
| TOTAL | 1.08 |

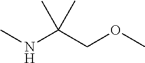

non-aqueous solution

| | |
|---|---|
| carbamate | — |
| bicarbonate | — |
| O—carbonate | — |
| dissolved | 0.5 |
| TOTAL | 0.5 |

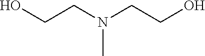

aqueous solution
(MDEA)

| | |
|---|---|
| carbamate | — |
| bicarbonate | 0.69 |
| O—carbonate | 0.15 |
| dissolved | — |
| TOTAL | 0.84 |

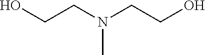

non-aqueous solution

| | |
|---|---|
| carbamate | — |
| bicarbonate | — |
| O—carbonate | — |
| dissolved | 0.25 |
| TOTAL | 0.25 |

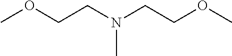

aqueous solution

| | |
|---|---|
| carbamate | — |
| bicarbonate | 0.76 |
| O—carbonate | — |
| dissolved | 0.05 |
| TOTAL | 0.81 |

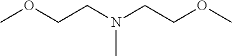

non-aqueous solution

| | |
|---|---|
| carbamate | — |
| bicarbonate | — |
| O—carbonate | — |
| dissolved | 0.21 |
| TOTAL | 0.21 |

*with trace amount of water present in the solution

### Examples 16-20

### General Procedure for Separation of H₂S from CO₂-Containing Gas Feed

Selectivity studies on removal of H₂S from CO₂-containing gas feeds were performed by purging an acid gas mixture through a reactor vessel containing an amine absorbent solution and analyzing the gas composition exiting the reaction vessel.

The experimental setup consisted of six main elements: (i) an N₂ purge gas supply, (ii) an acid gas supply containing a mixture of H₂S/CO₂/N₂, (iii) a 4-way valve to facilitate switching gas feeds between inlets for the N₂ gas and the acid gas mixture, (iv) a bubbler type reactor vessel containing an amine solution, (v) a mass spectrometer and (vi) acid gas scrubber. The 4-way valve selects the feed gas (N₂ or the acid gas mixture) and directs it to either the reactor vessel or to the scrubber. The outlet from the reactor vessel was connected to the scrubber with a connection to the mass spectrometer to permit real time analysis of the effluent gas composition. Approximately 15 cc of amine solution was placed into the reaction vessel (40 cc) containing an inlet tube that reaches near to the bottom of the vessel and an outlet tube connected to the gas scrubber and the mass spectrometer.

The reaction vessel containing the amine solution was first flushed with inert gas (e.g., N₂) to remove air from the head space. Flow of H₂S and CO₂ of a given concentration in N₂ was initiated and directed into the scrubber vessel in order to flush lines and stabilize the flow. After the reaction vessel was flushed with N₂ and the mass spectrometer detected low concentrations of O₂, H₂O and CO₂, the 4-way valve was turned to expose the amine solution to the H₂S/CO₂ mixture, at which point the run was considered to be at zero time. The mass spectrometer quantitatively detects the real-time off-gas composition, namely the concentration of CO₂ and H₂S as a function of time in the gas after treatment by the amine solution. Rigorous unit calibration was performed to calibrate the mass spectrometer signals taking into account for the delayed gas breakthrough due to filling the finite system volume. Each experimental sequence was composed of two runs: (1) gas flowing through an empty reactor vessel without amine and (2) the same gas composition flowing through the reactor vessel containing the amine solution.

Representative experimental data is presented below for 1M solutions of three amines Di-MeO-MDEA, MeO-MAMP, and 1,1,3,3-tetramethylguanidine (TMG) dissolved in NMP and two gas mixtures containing 0.1% H₂S/9.0% CO₂/90.9% N₂ and 0.5% H₂S/5.0% CO₂/94.5% N₂ purged through the amine solution at a flow rate of 100 sccm. The data includes the gas composition after treatment with an amine solution, the derived rates of H₂S and CO₂ capture as a function of reaction time and H₂S/CO₂ selectivities calculated as a ratio of relative concentrations of H₂S and CO₂ in the liquid and gas phases.

The results of the testing show that the equilibrium absorption factors and kinetics of the separation process should be factored into the operation of the unit: while the H₂S is initially absorbed selectively relative to the CO₂, continued passage of the acid gas mixture through the absorbent solution eventually leads to displacement of the H₂S by reaction of the amine groups with the CO₂. For this reason, the relative flow rates of the incoming gas mixture and of the absorbent solution should be controlled in combination with the compositions of the solution and the gas mixture so as to maintain the separation within the regime affording selectivity for H₂S absorption.

### Example 16

### H₂S Removal by MDEA-(MeO)₂ Dissolved in NMP

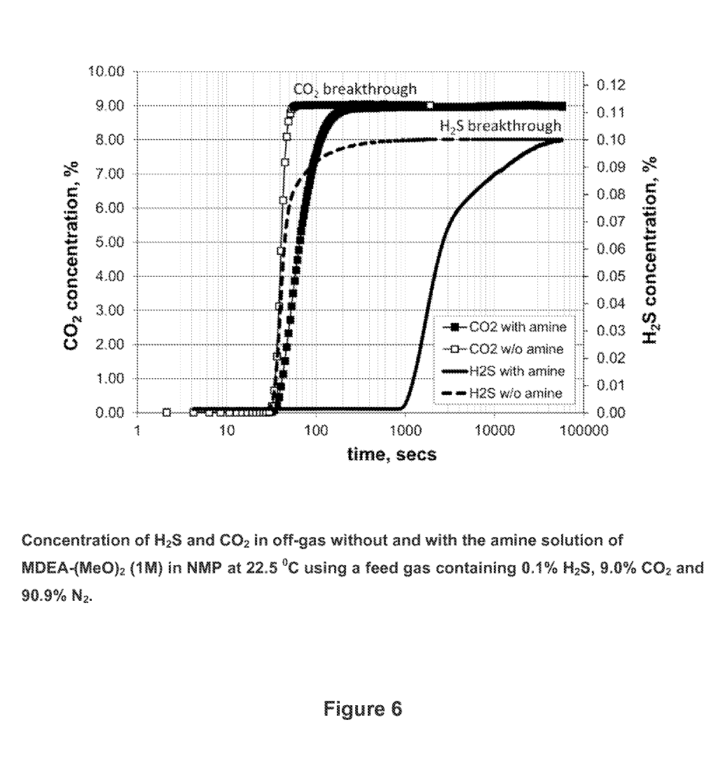

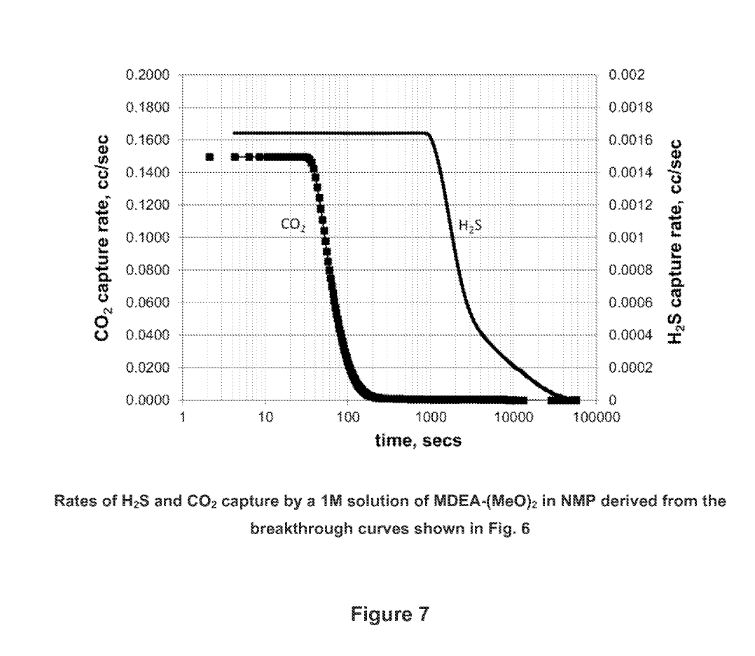

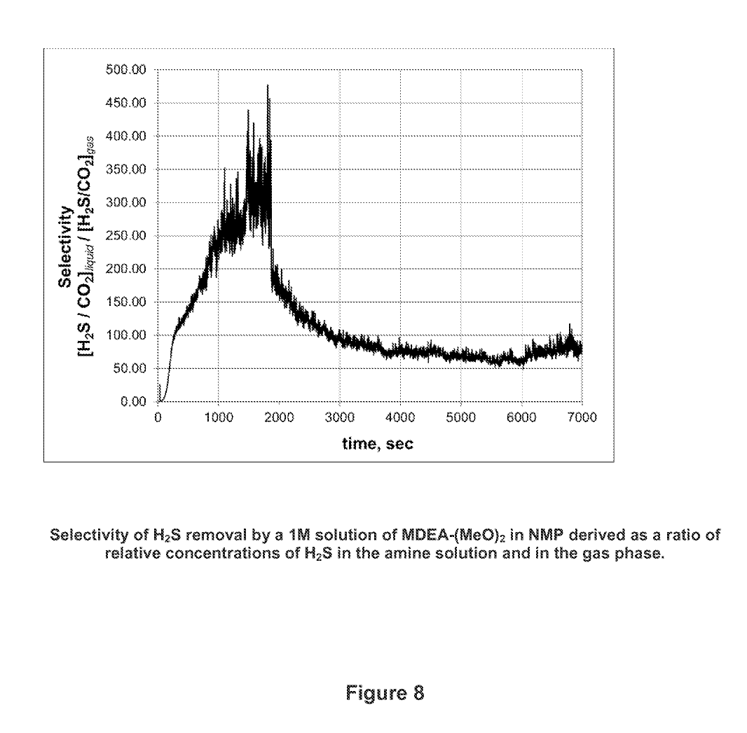

A gas mixture containing 0.1% H₂S, 9.0% CO₂ and 90.9% N₂ was purged through 15.1 g of a 1M solution of MDEA-(MeO)₂ in NMP at 22.5° C. and 0.4 psig (3 kPag). FIG. 6 shows the off-gas composition as breakthrough curves for H₂S and CO₂ gases purged at 100 ccm. CO₂ breaks through the amine solution in approximately 27 seconds, which is comparable to the breakthrough time using the reaction vessel without amine solution, and reaches an equilibrium concentration of 9%, the concentration in the unreacted gas mixture, in approximately 300 seconds. The absence of H₂S in the off-gas during the first 1000 seconds demonstrates that the H₂S is selectively removed from the gas stream by the amine solution during this time. After H₂S breakthrough is detected, the amine solution continues to remove H₂S from the gas feed during next 45000 seconds. FIGS. 7 and 8 show the rates of H₂S and CO₂ capture by the amine solution and H₂S/CO₂ selectivity derived as a ratio of relative concentrations of H2S in the amine solution and in the gas phase as a function of time derived from analysis of the off-gas composition. A selectivity for H₂S/CO₂ above 100 is detected during first 2500 seconds of the gas flow.

### Example 17

### H₂S Removal by Neat MDEA-(MeO)₂

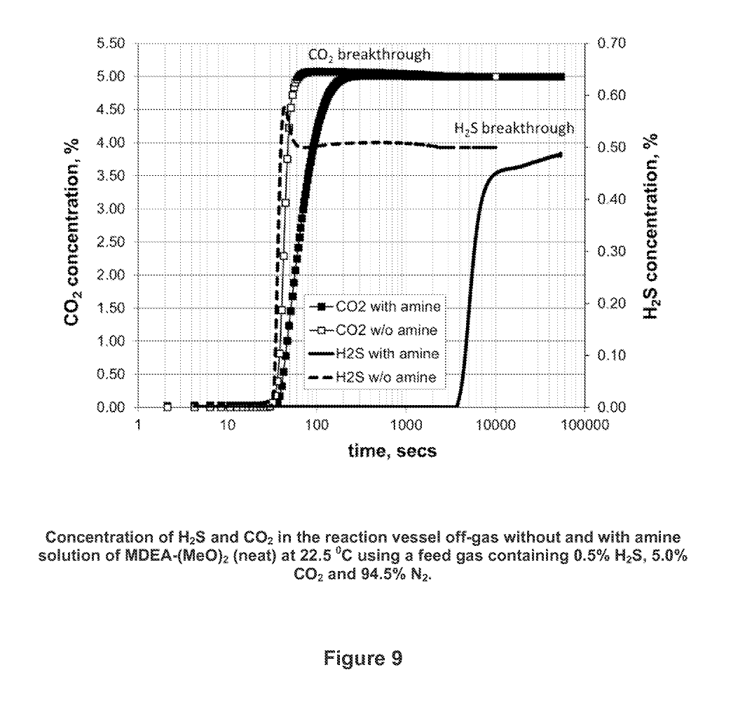

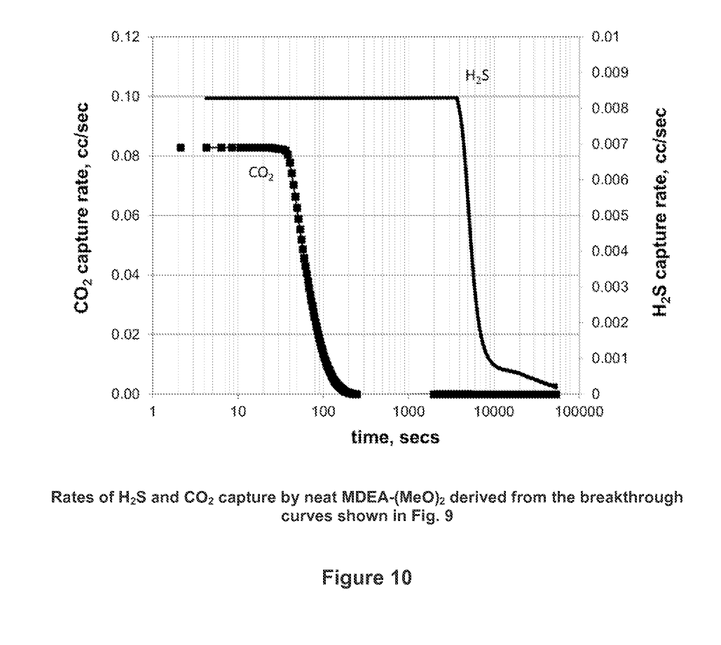

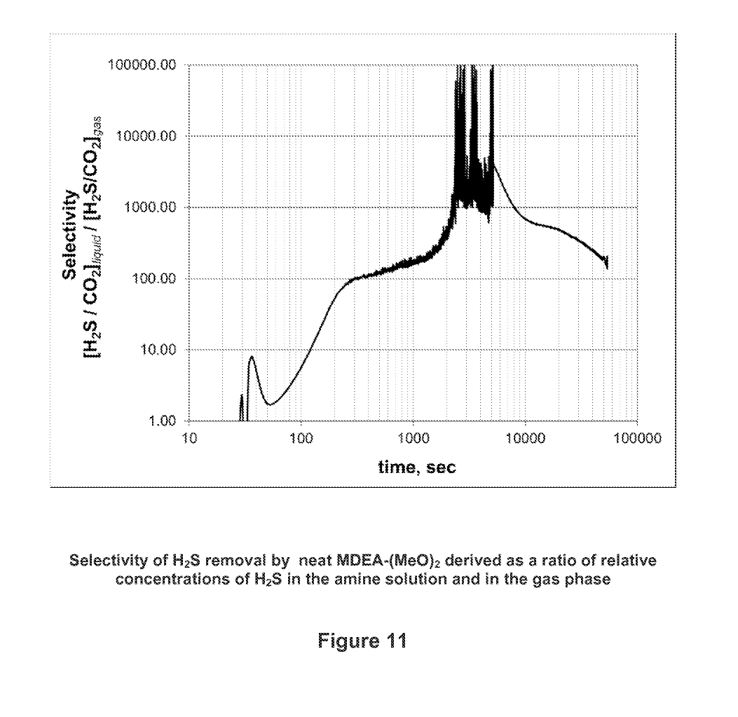

A gas mixture containing 0.5% H₂S, 5.0% CO₂ and 94.5% N₂ was purged through 15.1 g of neat MDEA-(MeO)₂ at 22.5° C. and 0.4 psig (3 kPaG). FIG. 9 shows the off-gas composition as breakthrough curves for H₂S and CO₂ gases purged at 100 ccm. CO₂ breaks through the amine solution in approximately 40 seconds, which is comparable to the breakthrough time using the reaction vessel without amine solution, and reaches an equilibrium concentration of 5%, the concentration in the unreacted gas mixture, in approximately 300 seconds. The absence of H₂S in the off-gas during the first 3200 seconds demonstrates that the H₂S is selectively removed from the gas stream by the amine during this time. After H₂S breakthrough is detected, the amine continues to remove H₂S from the gas feed during next 45000 seconds. FIGS. 10 and 11 show rates of H₂S and CO₂ capture by the amine solution and H₂S/CO₂ selectivity as a function of time derived from analysis of the off-gas composition. A selectivity for H₂S/CO₂ above 100 and exceeding 1000 is detected after 300 seconds of the gas flow. Capping of the hydroxyl groups in MDEA to produce MDEA-(MeO)₂ eliminates hydrogen bonding interactions with the hydroxyl groups and thereby reduces the solution viscosity so gas bubbles generated are small with a high surface to volume ratio. Pure MDEA becomes viscous, creating large gas bubbles with a low surface-to-volume ratio and an associated low H₂S surface concentration.

### Example 18

### H₂S Removal by MeO-MAMP Dissolved in NMP

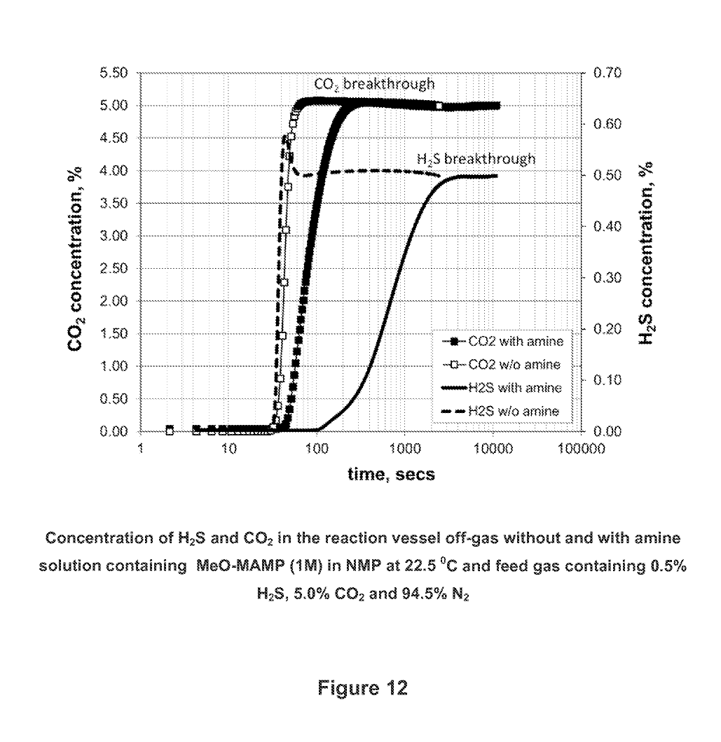

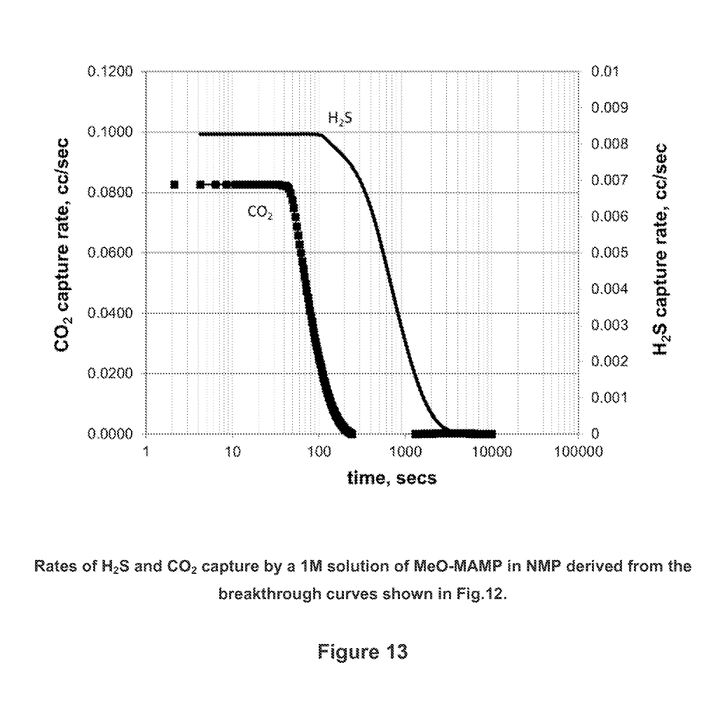

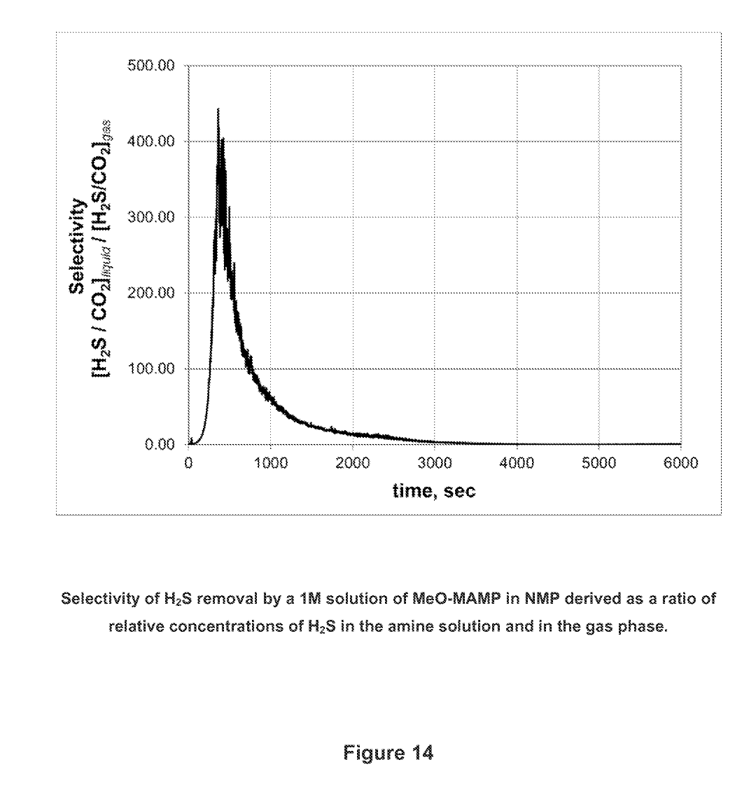

A gas mixture containing 0.5% H₂S, 5.0% CO₂ and 94.5% N₂ was purged through 15.0 g of a 1M solution of MeO-MAMP in NMP at 22.5° C. and 0.4 psig (3 kPag). FIG. 12 shows the off-gas composition as breakthrough curves for H₂S and CO₂ gases purged at 100 ccm. CO₂ breaks through the amine solution in approximately 40 seconds, which is comparable to the breakthrough time using a reaction vessel without amine solution, and reaches an equilibrium concentration of 5% in approximately 300 seconds. According to absence of H₂S in the off-gas during first 110 seconds, H₂S is selectively removed from the gas stream by the amine solution during this time. After H₂S breakthrough is detected, the amine solution continues to remove H₂S from the gas feed for next 4600 seconds of the reaction. FIGS. 13 and 14 show the rates of H₂S and CO₂ capture by the amine solution and H₂S/CO₂ selectivity as a function of time derived from analysis of the off-gas composition. A selectivity for H₂S/CO₂ above 100 is detected during the first 800 seconds of the gas flow.

### Example 19

### H₂S Removal by TMG Dissolved in NMP

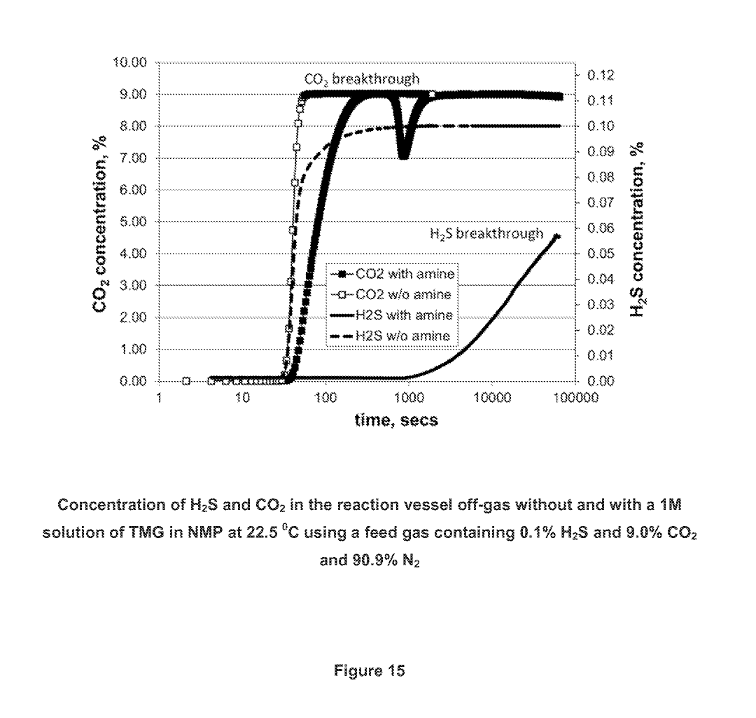

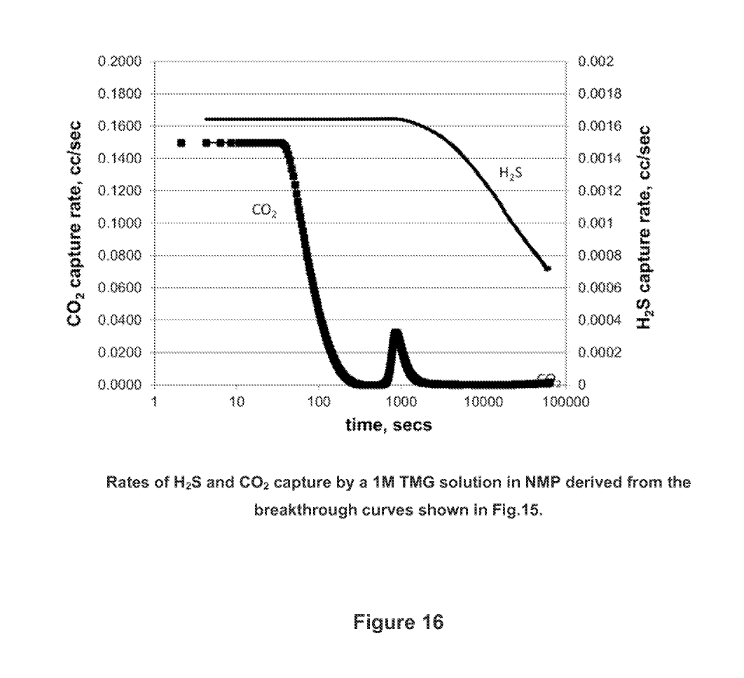

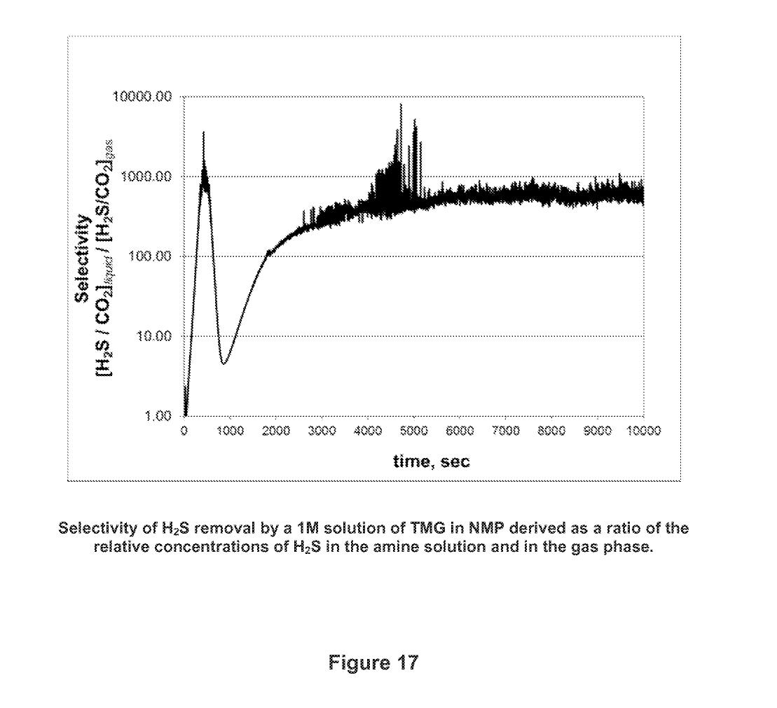

A gas mixture containing 0.1% H₂S, 9.0% CO₂ and 90.9% N₂ was purged through 15.0 g of a 1M solution of 1,1,3,3-tetramethylguanidine (TMG) in NMP at 22.5° C. and 0.4 psig (3 kPag). FIG. 15 shows the off-gas composition as breakthrough curves for H₂S and CO₂ gases purged at 100 ccm. CO₂ breaks through the amine solution in approximately 30 seconds, which is comparable to breakthrough time using the reaction vessel without amine solution, and reaches an equilibrium concentration of 9% in approximately 300 seconds. According to absence of H₂S in the off-gas during the first 1000 seconds, H₂S is selectively removed from the gas stream by the amine solution during this time. After H₂S breakthrough is detected, the amine solution continues to remove H₂S from the gas feed for next 15 hours of the gas flow. FIGS. 16 and 17 show rates of H₂S and CO₂ capture by the amine solution and H₂S/CO₂ selectivity as a function of time derived from analysis of the off-gas composition. A selectivity for H₂S/CO₂ above 100 is detected during first 700 seconds and after 1800 seconds of the gas flow.

### Example 20

### H₂S Removal by TMG Dissolved in DMSO

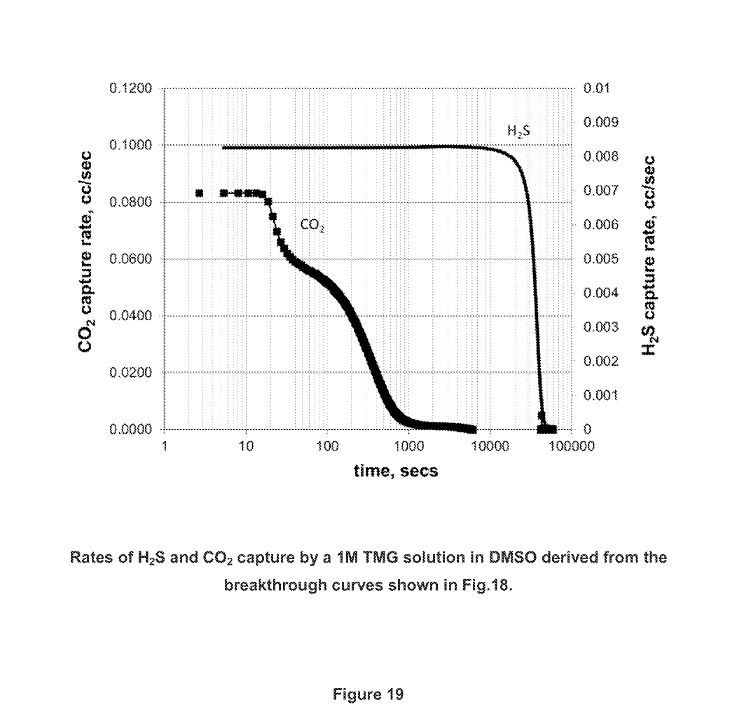

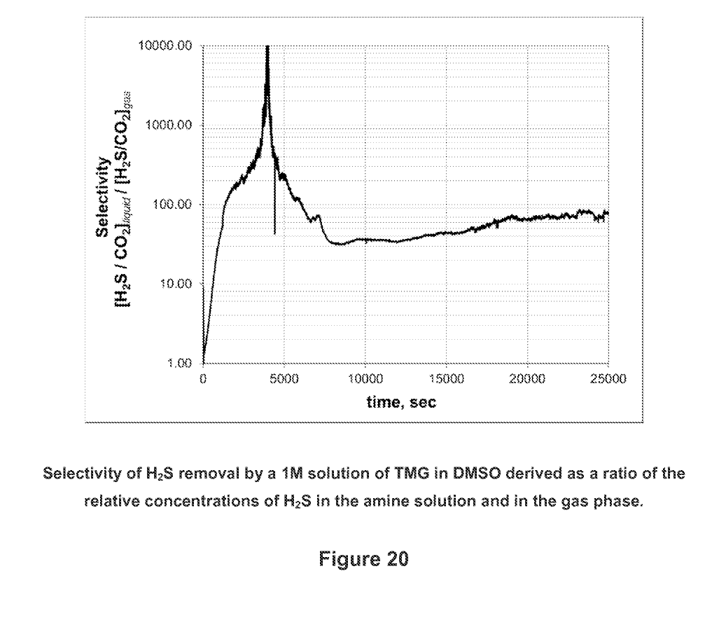

A gas mixture containing 0.5% H₂S, 5.0% CO₂ and 94.5% N₂ was purged through 15.0 g of a 1M solution of 1,1,3,3-tetramethylguanidine (TMG) (pKa 15.2) in DMSO at 22.5° C. and 0.4 psig (3 kPag). FIG. 19 shows the off-gas composition as breakthrough curves for H₂S and CO₂ gases purged at 100 ccm. CO₂ breaks through the amine solution in approximately 20 seconds, which is comparable to the breakthrough time using the reaction vessel without amine solution, and reaches an equilibrium concentration of 5% in approximately 2000 seconds. According to the absence of H₂S in the off-gas during the first 10000 seconds, H₂S is selectively removed from the gas stream by the highly basic amine solution during this time. After H₂S breakthrough is detected, the amine solution continues to remove H₂S from the gas feed for next 12 hours of the gas flow when H2S loading reached 0.87 mole of H₂S per mole of TMG. FIGS. 20 and 21 show rates of H₂S and CO₂ capture by the amine solution and H₂S/CO₂ selectivity as a function of time derived from analysis of the off-gas composition. A selectivity for H₂S/CO₂ above 100 is detected during first 6000 seconds of the gas flow.

1. A cyclic separation process for selectively separating hydrogen sulfide (H₂S) from a gas mixture which also comprises carbon dioxide (CO₂), which process comprises:
contacting a stream of the gas mixture with a solution of a capped alkanolamine H₂S absorbent at a pressure of at least 1 bara.

2. A process according to claim 1 which is operated at a pressure of 10 bara.

3. A process according to claim 1 which is operated at a pressure of 15 to 150 bara.

4. A process according to claim 1 in which the capped alkanolamine absorbent comprises an ether capped alkanolamine.

5. A process according to claim 1 in which the capped alkanolamine absorbent comprises a C₁-C₄ alkyl ether of a secondary or tertiary alkanolamine.

6. A process according to claim 1 in which the capped alkanolamine absorbent comprises 2-amino-prop-1-yl methyl ether, 2-amino-prop-1-yl ethyl ether, 2-N-methylamino-2-methyl-prop-1-yl methyl ether, 2-N-ethylamino-2-methyl-prop-1-yl ethyl ether, methoxyethoxyethoxyethanol-t-butylamine, ethoxyethoxyethoxyethanol-t-butylamine, propoxyethoxyethoxyethanol-t-butylamine, butoxyethoxyethoxyethanol-t-butylamine), N-(2-methoxyethyl)-N-methyl-ethanolamine, bis-(2-methoxyethyl)-N-methylamine, 2-amino-2-methyl-prop-1-yl methyl ether, 2-N-methylamino-2-methyl-prop-1-yl methyl ether, 2-N-ethylamino-2,2-dimethyl-prop-1-yl methyl ether or 2-(N,N-dimethylamino)-ethyl methyl ether

7. A process according to claim 1 in which the capped alkanolamine absorbent comprises bis-(methoxyethyl)aminomethane.

8. A process according to claim 1 in which the gas mixture is contacted with the solution for a contact time in which H₂S reacts with the amine groups of the capped alkanolamine without being substantially displaced by reaction with CO₂.

9. A process according to claim 8 in which the contact time between the gas mixture and the capped alkanolamine is less than 2 minutes.

10. A method of increasing the selectivity of an alkanolamine absorption process for H₂S absorption from a gas mixture which also comprises carbon dioxide (CO₂), which comprises contacting a stream of the gas mixture with a solution of a capped alkanolamine H₂S absorbent having at least one capped hydroxyl group at a pressure of at least 1 bara.

11. A method according to claim 10 in which the capped hydroxyl groups of the capped alkanolamine H₂S absorbent comprise C₁-C₄ alkoxy groups.

12. A process according to claim 10 in which the capped alkanolamine absorbent comprises 2-amino-propy-1-yl methyl ether, 2-amino-prop-1-yl ethyl ether, 2-N-methylamino-2-methyl-prop-1-yl methyl ether, 2-N-ethylamino-2-methyl-prop-1-yl ethyl ether, methoxyethoxyethoxyethanol-t-butylamine, ethoxyethoxyethoxyethanol-t-butylamine, propoxyethoxyethoxyethanol-t-butylamine or butoxyethoxyethoxyethanol-t-butylamine, N-(2-methoxyethyl)-N-methyl-ethanolamine, bis-(2-methoxyethyl)-N-methylamine, 2-amino-prop-1-yl methyl ether, 2-amino-2-methyl-prop-1-yl methyl ether, 2-N-methylamino-2-methyl-prop-1-yl methyl ether, 2-N-ethylamino-2-methyl-prop-1-yl methyl ether or 2-(N,N-dimethylamino)-ethyl methyl ether.

13. A process according to claim 10 in which the H₂S reacts with the amine groups of the capped alkanolamine without being substantially displaced by reaction with CO₂.

14. A process according to claim 10 in which the contact time between the gas mixture and the capped alkanolamine is less than 2 minutes.

15. An alkanolamine separation process for a natural gas stream containing H₂S and CO₂ with improved selectivity for H₂S separation relative to CO₂ separation at high pressures under conditions approaching absorbed H₂S/CO₂ equilibrium, which comprises:
(i) contacting a natural gas stream containing H₂S and CO₂ in an absorption zone with a liquid solution of a sterically hindered capped alkanolamine to absorb H₂S preferentially over CO₂ and form a rich stream of the absorbed H₂S in the alkanolamine solution;
(ii) passing the rich stream from the absorption zone to at least one regeneration zone and desorbing the absorbed H₂S as gas from the alkanolamine solution to form a lean solution containing a reduced concentration of absorbed H₂S relative to the rich stream and
(iii) returning the lean stream to the absorption zone.

16. A method according to claim 15 in which the capped hydroxyl groups of the capped alkanolamine H₂S absorbent comprise C₁-C₄ alkoxy groups.

17. A process according to claim 16 in which the capped alkanolamine absorbent comprises 2-amino-propy-1-yl methyl ether, 2-amino-prop-1-yl ethyl ether, 2-N-methylamino-2-methyl-prop-1-yl methyl ether, 2-N-ethylamino-2-methyl-prop-1-yl ethyl ether, methoxyethoxyethoxyethanol-t-butylamine, ethoxyethoxyethoxyethanol-t-butylamine, propoxyethoxyethoxyethanol-t-butylamine or butoxyethoxyethoxyethanol-t-butylamine, N-(2-methoxyethyl)-N-methyl-ethanolamine, bis-(2-methoxyethyl)-N-methylamine, 2-amino-prop-1-yl methyl ether, -2-amino-2-methyl prop-1-yl methyl ether, 2-N-methylamino-2-methyl-prop-1-yl methyl ether, 2-N-ethylamino-2-methyl-prop-1-yl methyl ether or 2-(N,N-dimethylamino)-ethyl methyl ether.

18. A process according to claim 15 in which the natural gas stream is contacted with the capped alkanolamine liquid solution at a pressure of at least 1 bara.

19. A process according to claim 15 in which the capped alkanolamine liquid solution comprises a non-aqueous solution.

20. A process according to claim 15 in which the absorbed H₂S is desorbed from the alkanolamine solution at a temperature higher than the temperature at which the gas stream is contacted with the capped alkanolamine liquid solution in the absorption zone.

21. A process according to claim 15 in which the gas mixture is contacted with the solution for a contact time in which H₂S reacts with the amine groups of the capped alkanolamine without being substantially displaced by reaction with CO₂.

22. A process according to claim 21 in which the contact time between the gas mixture and the capped alkanolamine is less than 2 minutes.

23. A process according to claim 15 in which the alkanolamine comprises an alkanolamine having at least one tertiary amine group.

24. A process according to claim 23 in which the liquid solution comprises a non-aqueous solution.

25. A process according to claim 15 in which the alkanolamine comprises bis-(2-methoxyethyl)-N-methylamine.

26. A cyclic separation process for selectively separating hydrogen sulfide (H₂S) from a gas mixture which also comprises carbon dioxide (CO₂), which process comprises: contacting a stream of the gas mixture with a solution of a sterically hindered secondary or tertiary amine H₂S absorbent at a pressure of at least 1 bara.

27. A process according to claim 26 which is operated at a pressure of 10 bara.

28. A process according to claim 26 which is operated at a pressure of 15 to 150 bara.

29. A process according to claim 26 in which the sterically hindered secondary or tertiary amine comprises a guanidine, amidine, biguanide, piperidine or piperazine.

30. A process according to claim 26 in which the sterically hindered secondary or tertiary amine comprises tetramethylguanidine, pentamethylguanidine, 1,4-dimethylpiperazine, 1-methylpiperidine, 2-methylpiperidine or 2,6-dimethylpiperidine.

31. A process according to claim 26 in which the solution of the sterically hindered secondary or tertiary amine is a non-aqueous solution.

32. A process according to claim 30 in which the solution of the sterically hindered secondary or tertiary amine is a non-aqueous solution.

33. A process according to claim 26 in which the gas mixture is contacted with the solution for a contact time in which H₂S reacts with the amine groups of the sterically hindered secondary or tertiary amine H2S absorbent without being substantially displaced by reaction with CO₂.

34. A cyclic separation process for a natural gas stream containing H₂S and CO₂ with improved selectivity for H₂S separation relative to CO₂ separation at high pressures under conditions approaching absorbed H₂S/CO₂ equilibrium, which comprises:
(i) contacting a natural gas stream containing H₂S and CO₂ in an absorption zone with a non-aqueous liquid solution of a sterically hindered secondary or tertiary amine to absorb H₂S preferentially over CO₂ and form a rich stream of the absorbed H₂S in the alkanolamine solution;
(ii) passing the rich stream from the absorption zone to at least one regeneration zone and desorbing the absorbed H₂S as gas from the amine solution to form a lean solution containing a reduced concentration of absorbed H₂S relative to the rich stream and
(iii) returning the lean stream to the absorption zone.

35. A process according to claim 34 in which the gas mixture is contacted with the solution for a contact time in which H₂S reacts with the amine groups of the sterically hindered secondary or tertiary amine without being substantially displaced by reaction with CO₂.
